(19) United States
(12) Patent Application Publication
(10) Pub. No.: US 2026/0235565 A1
(43) Pub. Date: Aug. 13, 2026

(54) REAL-TIME MONITORING OF CHROMATOGRAPHIC PURIFICATION OF BIOLOGICAL SUBSTANCES

(71) Applicant: Nyctea Technologies AB, Mölndal (SE)

(72) Inventors: Gustav FERRAND-DRAKE DEL CASTILLO, Göteborg (SE); Maria KYRIAKIDOU, Göteborg (SE)

(21) Appl. No.: 19/474,970

(22) PCT Filed: Apr. 16, 2024
(86) PCT No.: PCT/SE2024/050367

§ 371 Date: Oct. 13, 2025

(30) Foreign Application Priority Data
Apr. 18, 2023 (SE) 2350461-6

(51) Int. Cl. G01N 30/88; G01N 30/02; G01N 30/50

(52) U.S. Cl. CPC G01N 30/88; G01N 30/50; G01N 2030/027

(57) ABSTRACT

A chromatography unit (200) and system (400) for use in real-time monitoring of purification of a biological substance. The unit (200) comprising: a chromatography column (100) comprising a housing (110), an electrically conductive support structure (101, 101a-101n) arranged in the housing (110), a counter electrode (102) and optionally also a reference electrode (103) arranged in the housing. The support structure (101, 101a-101n) is provided with a polyelectrolytic coating (111) switchable between a first state in which a biological substance to be purified is captured and a second state in which a captured biological substance is released. A voltage generator (300) is connected to the support structure (101, 101a-101n) and to the counter electrode (102) and optionally to the reference electrode and provides an AC voltage signal at a bias between the support structure (101, 101a-101n) and the counter electrode (102)/reference electrode (103). A recorder (300) is arranged to record a current signal and/or potential signal generated.

### TECHNICAL FIELD

The present disclosure is related to a chromatography unit, a chromatography system and a chromatographic method for real-time monitoring of purification of biological substances.

### BACKGROUND ART

Many biological products, in particular biopharmaceuticals, need to meet extremely high demands on purity and potency. In downstream processing, the biological products are concentrated and separated from impurities. This requires a long sequence of separation steps. Chromatography is the central technique used for purification of biopharmaceutical products. The cost of purification by chromatography becomes very expensive due to an accumulated loss of product with each repeated step. Another major cost contributor is the time and resources required for performing frequent labor-intensive analytical techniques off-line to assess if acceptable purity, potency of the product has been reached.

The dominating strategy for process analytical technology is to place different types of sensors process stream in-line with the chromatography column to measure physiochemical properties. A general disadvantage with in-line sensors is that the location of information collection is far away from where the actual purification takes place, on the surface of the chromatography media. An alternative strategy is to place highly miniaturized sensors in-situ of the chromatography column. These sensors can, however, only sense within a very small volume of the column and the data is not surface specific, meaning it is hard to subtract the background signal from the bulk process liquid, making the quality of information obtained in-situ highly similar to the data obtained in-line.

Commercial chromatography systems are equipped with in-line sensors that measure refractive index, absorbance, conductivity, and the pH of the process flow. The standard in-line sensors are not product specific, for instance all biomolecules even impurities absorb UV light. The main purpose of these sensors is to monitor the purification process qualitatively and to track the progression of the chromatography cycle, binding, rinsing and elution.

One strategy to detect specifically the product is by combining UV light sensors with in-line localized surface plasmon resonance (LSPR) sensors functionalized with affinity ligands WO2020009642. This way the product is efficiently detected in the effluent despite presence of by-products. Some problems with this approach is that it only indirectly reports that the column is saturated with a time delay. Once it is saturated it will provide no new information about the product until the next bind-and-elute cycle, and it cannot report the actual amount of product bound to the chromatography support at any given time.

Computational modelling of the chromatography purification process, also called in-silico chromatography or digital twins modelling, has been explored for yield optimization and for quality prediction (potency and purity) (US20210149361A1). The obvious advantage of modelling the purification is that with a minimum number of physical experiments the computer model can be used to predict the outcome of the purification. However, input for these models rely on data collected by existing in-line sensors positioned in the process flow at the inlet and outlet, which may limit the quality of the predictions. Furthermore, the performance of columns drift between purification cycles, which will overtime require re-calibration of the model data, and where use of wrong parameters will lead to inaccurate predictions and the risk for loss of product. As a final remark computational modelling is greatly useful within a specific domain, but breaks down under new circumstances, different modality, different type of chromatography and new experimental data is needed.

Today quality critical attributes are exclusively measured off-line by technologies like SPR, ELISA, and HPLC. HPLC and mass spectrometry are used to test for process impurities and size exclusion chromatography for presence of aggregates and fragment impurities. Most important is determination of potency, i.e. equilibrium binding constant, Kd which is measured by ELISA or SPR-immunoassays. Analytical validation is routinely employed between every unit operation of the purification, starting at the cell culture harvest and until the final processing steps, where at some point the product is cleared, meaning it is of sufficient purity for final formulation. Off-line or at-line analytics is highly resource demanding and contributes substantially to product cost. The assay standards need to be routinely controlled and maintained. Running the protocols and interpretation of the results requires highly skilled and trained staff.

### SUMMARY OF THE INVENTION

It is an object of the present disclosure to provide a chromatography unit, a chromatography system and a chromatographic method for real-time monitoring of purification of biological substances.

The invention is defined by the appended independent patent claims. Non-limiting embodiments emerge from independent claims, the appended drawings and the following description.

According to a first aspect there is provided a chromatography unit for use in a chromatography system for real-time monitoring of purification of a biological substance. The chromatography unit comprises a chromatography column comprising a housing provided with a solution inlet and a solution outlet. A support structure is arranged in the housing in a space between the solution inlet and the solution outlet, and being arranged such that an electrolytic solution arranged to flow from the solution inlet to the solution outlet is contacting at least a portion of the support structure, wherein at least a portion of a surface of said support structure is electrically conductive. The chromatography unit further comprises a) a counter electrode arranged in the housing and arranged in electrical connection with the support structure via the electrolytic solution arranged to flow from the solution inlet to the solution outlet, or b) a counter electrode and a reference electrode arranged in the housing and arranged to be in electrical connection with each other and with the support structure via the electrolytic solution arranged to flow from the solution inlet to the solution outlet. At least a portion of a surface of the support structure is provided with a polyelectrolytic coating, the polyelectrolytic coating being arranged to be switchable between a first state in which a biological substance to be purified is captured in the support structure and a second state in which captured biological substance is released from the support structure. A voltage generator is arranged to be connected to the support structure and a) to the counter electrode, and being arranged to provide an AC voltage signal at a bias between the support structure and the counter electrode, or b) to the counter electrode and the reference electrode, and being arranged to provide an AC voltage signal at a bias between the support structure and the reference electrode. A recorder is arranged to record a current signal and/or potential signal generated between the support structure and the counter electrode or between the support structure and the reference electrode.

The described chromatography unit may, hence, be a two-electrode set-up comprising the support structure/working electrode and the counter electrode, or be a three-electrode set-up comprising the support structure/working electrode, the counter electrode and the reference electrode. In the tree-electrode set-up, the AC voltage is applied between the support structure and the reference electrode and the counter electrode acts as a current collector. The polyelectrolytic coating is arranged to be switchable between a first state in which a biological substance to be purified is captured at the support structure and a second state in which captured biological substance is released from the support structure. The polyelectrolytic coating may be put in the first state by changing/switching the bias potential difference e.g. the DC potential of the applied AC potential (by means of the voltage generator) and be put in the second state by changing/switching the bias potential difference of the applied AC potential. This is, hence, an electrochemical switching of the polyelectrolytic coating between the first and second states. Alternatively, the polyelectrolytic coating may be put in the first state using an electrolytic running buffer with certain properties/conditions such as salt concentration, buffer species, temperature, and in the second state by changing the one or several properties/conditions of the running buffer by for instance adding elution buffer species to the electrolyte. This is, hence, a solution induced non-electrochemical switching of the polyelectrolytic coating between the first and second states as is custom in standard chromatography.

In this chromatography unit, a biological substance/biomolecular product to be purified may be captured/bound to and released from the polyelectrolytic coating with minimal interference from the applied AC voltage signal between the support structure and the counter electrode or reference electrode. This is accomplished by as a result of setting a low bias potential magnitude for the AC voltage signal between the support structure and the counter electrode or reference electrode, the recorder can then measure at any given time point, in real time, the degree of biological substance that is bound to/captured by the support structure without interfering in the binding of the biological substance, without interfering with the bound biological substance and without interfering with the releasing/elution of the biological substance from the support structure.

By recording a current signal and/or potential signal generated between the support structure and the counter electrode or the reference electrode, the purification process of a biological substance on the surface of the chromatography support structure can be measured/followed in real time. Not only the surface binding process can be probed, but also in-situ bulk solution properties and in-situ information regarding binding of substance to the working electrode, degree of column loading, potency, concentration, pH conductivity etc., may be obtained.

The above should be compared to conventional chromatography that rely on in-line sensors to record limited information of the product quality and that further measures quality critical attributes off-line.

The electric signal used to probe events on the surface and in the bulk can be an electrochemical impedance signal or any modulated electric signal. This kind of measurement is known as electric impedance spectroscopy (EIS). In EIS a small-amplitude perturbing sinusoidal voltage with a particular frequency centred on a fixed potential value is applied and the resulting current is recorded. From this the impedance Z(ω)=Z ReZ(ω)+j ImZ(ω)=Z0 exp(jφ), where ω=2πf, is measured where the current magnitude Z₀ is collected as well as the phase shift, φ, alternatively the impedance is represented in the real and imaginary parts. EIS is an established technique for analytical scale biosensing.

The support structure of the chromatography unit may have a stacked structure comprising at least two discrete layers physically separated from each other and being arranged such that an electrolytic solution arranged to flow from the solution inlet to the solution outlet is contacting at least a portion of each discrete layer, wherein at least one of the discrete layers is provided with a polyelectrolytic coating, and wherein the voltage generator is arranged to be connected to each or to at least a majority of the discrete layers of the support structure, and the recorder is arranged to record a current signal and/or potential signal generated between each discrete layer, or a majority of the discrete layers, of the support structure and the counter electrode or the reference electrode.

This permits independent, and possibly simultaneous, electronic monitoring and control of the discrete layers of the support structure. Signals may be collected in a parallel fashion and simultaneously from all discrete layers, or at least from a majority of the discrete layers, of the support structure. Thereby, a concentration of a biological substance that is bound to the support structure in the different discrete layers can be measured. Thereby, an optimized elution concentration control may be based on features such as maximum eluate concentration. Information about when elution has been completed may be obtained to reduce excessive use of chemicals to elute, or use of shifted bias potential to elute.

The support structure may comprise at least a first and second discrete layer, wherein the polyelectrolytic coating arranged on the first discrete layer differs in chemical composition from the polyelectrolytic coating arranged on the second discrete layer.

That the polyelectrolytic coatings differ in chemical composition means that the polyelectrolytic coatings may have different surface chemical properties, such as being provided with affinity ligand, having a hydrophobic exchange chemistry, having an ion-exchange chemistry. One discrete layer may for example be arranged with a polyelectrolytic coating functionalized with an affinity ligand, and acts as a capture step, a subsequent discrete layer (in the flow direction) may have a polyelectrolytic coating that has a cationic ion-exchange chemistry, and the next (in the flow direction) discrete layer may have a multi-modal anionic ion-exchange chemistry coupled with hydrophobic interactions.

As binding concentration may be measured in real-time along each discrete layer of the support structure in the flow direction, this may provide local information in the flow direction i.e. the axial direction of the chromatography unit, indicating when the chromatography unit has reached its total binding capacity with high accuracy.

The above should be compared with conventional chromatography where several segmented layers of resins or membrane with different surface chemistry (hydrophobic interactions, affinity, anionic/cationic ion exchange) are controlled by different elution chemicals that are not mutually compatible, some chromatography materials are not compatible with some elution chemicals for instance, and where no local information of binding and release can be monitored in-situ.

According to a second aspect there is provided a chromatography system comprising the chromatography unit described above.

The chromatography system may apart from the chromatography unit, comprise a liquid management system containing buffer pumps, a sample pump, mixer injection valves, and column valves for administering the flow path through the column, followed by an outlet valve connected to a sample fractionation apparatus. The chromatography column is connected in-line.

According to a third aspect there is provided a method for real-time monitoring of chromatographic purification of a biological substance, comprising:
i) obtaining an electrolytic solution volume comprising a biological substance to be purified and contaminant(s),
ii) providing the chromatography system above,
iiia) applying an AC potential with a bias potential difference between the support structure and the counter electrode, where the bias voltage is set with respect to the open circuit potential which is measured between the support structure and the counter electrode, or against the reference electrode and where the open circuit potential is measured once in the beginning of the chromatography experiment, or continually before each AC potential signal is applied or,
iiib) applying an AC potential with a fixed bias potential difference between the support structure and the reference electrode,
iv) supplying an electrolytic running buffer to the housing at the solution inlet of the chromatography column, equilibrating the polyelectrolytic coating of the support structure in the electrolytic running buffer,
v) setting the polyelectrolytic coating arranged on the support structure in its first state,
vi) supplying the electrolytic solution volume comprising a biological substance to be purified and contaminant(s) to the housing at the solution inlet of the chromatography column, thereby biological substances are captured in the polyelectrolytic coating on the support structure,
vii) setting the polyelectrolytic coating arranged on the support structure in its second state, thereby captured biological substances are released from the support structure, and viii) recording a current signal and the associated impedance resulting from the AC potential signal applied between the support structure and the counter electrode or between the support structure and the reference electrode during step iv) to vii).

The AC potential with a bias potential difference is a continuous non-invasive AC voltage signal applied between the conductive support structure and the counter electrode or between the conductive support structure and the reference electrode applied throughout the chromatography bind-and-elute cycle, i.e. steps vi) and vii).

Step viii) of recording the current signal and/or potential signal generated, may be a continuous recording. Alternatively, the recording may be performed at regular or irregular intervals for shorter or longer time-periods, such as recording every other millisecond etc.

Using the monitored open circuit, the potential chromatography cycle can be monitored.

Step iv) of supplying an electrolytic running buffer to equilibrate the polyelectrolytic coating of the support structure can be evaluated by the generated recorded current signal and/or potential signal to confirm that the polyelectrolytic coating of the support structure is in an equilibrated state.

Step viii) of recording the current signal and/or potential signal generated, may be used to measure the degree of binding/saturation of the biological substance to the polyelectrolytic coating of the support structure (in step vi), detect the relative amount of released biological substance from the support structure (in step vii).

When the support structure has a stacked structure as described above comprising at least two discrete layers, in step iiia) an AC potential with a bias potential difference may be applied between each or at least a majority of the discrete layers and the counter electrode, and, optionally, an open circuit potential may be measured between each or at least a majority of the discrete layers and the counter electrode, or in step iiib) an AC potential with a bias potential difference may be applied between each or at least a majority of the discrete layers and the reference electrode, and in step viii) recording a current signal and/or potential signal generated between each or at least a majority of the discrete layers and the counter electrode or between each or at least a majority of the discrete layers and the reference electrode during step iv) to vii).

Step v) of setting the polyelectrolytic coating arranged on the support structure in its first state may comprise changing/switching the bias potential difference of the applied AC potential.

Step vii) of setting the polyelectrolytic coating arranged on the support structure in its second state may comprise changing/switching the bias potential difference of the applied AC potential.

By applying a changed bias potential difference of the applied AC potential compared to in step v), vi), elution of the bound biomolecules may be by triggered through electrochemical reactions that alter the interfacial pH of the electrode by switching the polyelectrolytic coating to its second state.

Alternatively, step v) of setting the polyelectrolytic coating arranged on the support structure in its first state may be performed in step iv) through the electrolytic running buffer used.

Alternatively, step vii) of setting the polyelectrolytic coating arranged on the support structure in its second state may comprise adding an elution buffer to the chromatography unit.

The elution buffer or the running buffer with added elution component comprises an elution chemical that disrupts the interaction between the polyelectrolytic coating on the support structure and the biological substance.

The method may further comprise a rinsing step after step vi).

Rinsing may be performed using the running electrolytic buffer or another running buffer, a rinsing buffer. Through the rinsing unbound biological substances and contaminants/impurities are washed away, equilibrating the binding of the biological substance to the polyelectrolytic coating on the support structure.

The step of rinsing can be evaluated by the generated recorded current signal and/or potential signal to monitor the rinsing step and the removal of unbound impurities from polyelectrolytic coating.

The method may further comprise a step of collecting biological substances released from the support structure and exiting through the solution outlet.

The method may also comprise a final step of re-equilibrating the polyelectrolytic coating of the support structure by rinsing with electrolytic buffer solution and/or applying a clean-in-place treatment comprising a chemical that cleans the chromatography unit. Thereafter, the method can be restarted and new biological substances purified.

The applied biased alternating potential may have a bias potential of +/−1.5 V.

The applied biased alternating potential may have a frequency of 1 μHz to 1 MHz.

Alternatively, the applied biased alternating potential may have a frequency of 1 mHz to 1 MHz.

If the applied biased alternating potential has a frequency of 1 Hz to 1 MHz, it is possible to measure the double layer capacitance, and a redox active species resistance to charge transfer, at the electrolyte electrode interface. On the support structure, translocation of ions and a build-up of charges through the polyelectrolytic coating surface is hindered by presence of bound biological substances to the surface, which slows down the rate of translocation of ions and redox active species through the polyelectrolytic coating to the underlying electrode surface creating a capacitance and resistance change. Thereby, confirming that there are biological substances bound to the surface as opposed to the case when the polyelectrolytic coating is completely empty and evacuated from biological substances, in which case ions can translocate the coating freely with relatively little hindrance.

If the applied biased alternating potential has a frequency of 1 μHz to 100 Hz, diffusion, charge transfer resistance and possibly electrolytic solution conductivity information can be measured. This as the ions have enough time to translocate the polyelectrolytic coating regardless of the degree of bound biological substances on the coating, and regardless of the state the polyelectrolytic coating on the support structure. The measured impedance signal exactly overlaps an in-line measured conductivity signal measured with an in-line conductivity sensor.

There is an overlap in the frequency spectrum between 1 mHz to 1 kHz where a mixture of both bulk and surface effects may be present in the measured impedance signal.

At very high frequencies, exceeding 1 MHz, the inductance of the electrochemical cell, connecting wires, and limitations in the electric hardware may substantially contribute to and flood the impedance spectra.

An amplitude of the alternating potential may be 1 μV to 100 mV.

The amplitude of the alternating potential may be 1 to 50 mV, optionally from 5 mV to 20 mV, from 5 mV to 15 mV, from 8 mV to 12 mV, or from about 10 mV.

The method may further comprise a step of, based on the recorded current signal and/or potential signal from step viii), provide in real-time information on: bulk electrolytic solution properties, degree of binding/saturation of the biological substance captured by the polyelectrolytic coating, degree of column loaded with biological substance, potency of the biological substance, concentration of the biological substance captured by the polyelectrolytic coating, pH of the electrolytic solution, and/or conductivity of the electrolytic solution.

In order to provide a concentration of the biological substance captured by the polyelectrolytic coating, information about the area of the support structure with polyelectrolytic coating and binding capacity of the coating is needed.

The provided real-time information may be used in a feedback loop to control step vi) and/or step vii).

Thereby, it is possible to program the chromatography system to stop supplying product before the support structure of the chromatography unit oversaturates and to prevent excess loss of product due to sample loss. Furthermore, during elution it would be possible to monitor exactly when the support structure of the chromatography unit becomes empty and immediately return to pumping the running buffer electrolytic solution, which minimizes the exposure of the biological substance to potentially harmful elution chemicals. With exact monitoring of the degree of binding state of the support structure of the chromatography unit it is possible to design intensified feedback loops for highly efficient cycle times for the purification process in the chromatography system.

The electrolytic running buffer and the electrolytic solution volume comprising a biological substance to be purified may be supplied to the housing at the solution inlet at a flow rate of 0.1-20 ml/min.

In one example, the flow rate is 0.1-10 ml/min.

Preferably the flow rate is held constant throughout the chromatography cycle to prevent distortion of the impedance signal that do not arise from the application of sample, binding of biomolecules to the support structure, elution of biomolecules from the support structure and return to the original baseline value for an empty support structure. The flow rate can be continuously be adjusted in a step-wise fashion but with an step-wise immediate change in the flow rate of maximum+/−0.5 ml/min.

### BRIEF DESCRIPTION OF THE DRAWINGS

FIG. 1a shows a chromatography column for use in a chromatography system. In FIG. 1b is shown the chromatography column of FIG. 1a in a cross-sectional view. The chromatography column has arranged in a housing a conductive support structure, i.e. a working electrode, a counter electrode and, optionally, a reference electrode. At least a portion of a surface of the support structure is provided with a polyelectrolytic coating that is compatible with electrochemistry is switchable between a first state in which a biological substance to be purified is captured in the support structure and a second state in which captured biological substance is released from the support structure.

FIG. 2 shows schematically a chromatography system that uses a conventional chromatography column.

FIG. 3. shows a chromatography system comprising the chromatography column of FIG. 1b. A potentiostat is connected to the support structure, to the counter electrode and to the reference electrode, and is arranged to provide a potential difference between the support structure and the reference electrode as a biased alternating potential. The counter electrode acts as a current collector. The potentiostat is being arranged to apply and record a current signal and/or potential signal generated between the support structure and the reference electrode. Hence, with this system, events taking place on the support structure and in the surroundings thereof can be recorded, using electrochemical impedance spectroscopy (EIS).

FIG. 4 shows a conceptual comparison of data that is obtained when a chromatography purification process is monitored in real-time (upper graph) directly on a conductive chromatography material using EIS, with the data obtained from a chromatographic purification process that is monitored indirectly (lower graph) by downstream in-line analytical tools such as a UV sensor.

FIG. 5 shows experimental data that compares measurement output from direct real-time data of the binding and elution of a monoclonal antibody product to a protein A coated electrode by electrochemical impedance spectroscopy with the measurement output from an in-line UV sensor during a bind-and-elute cycle.

FIG. 6 shows a conventional purification workflow for chromatographic purification of biopharmaceuticals that uses a combination of in-line sensors and off-line analytical techniques.

FIG. 7 shows a purification workflow for biomolecule products using the chromatographic system of FIG. 3 wherein in-line monitoring of quality critical attributes is employed.

FIG. 8. shows a Nyquist diagram from EIS measurements where the imaginary part is plotted as a function of the real part of the impedance during a purification process of binding and elution of a bioproduct to/from a support structure of a chromatographic column of FIG. 1b.

FIG. 9 shows an electrical circuit representation used to analyze electrochemical impedance spectroscopy measurements on a polyelectrolytic coating, such as a polymer brush, coated on the working electrode of the chromatography unit in FIG. 1b.

FIG. 10 shows a Bode diagram of an EIS measurements repeatedly performed throughout a purification process cycle where the modulus and the phase components of the measured impedance are plotted as a function of the frequency.

FIG. 11 shows analysis of the data shown in FIG. 10 for one selected frequency, 1258 Hz, where the modulus of the impedance signal (crosses) is plotted as a function of time (solid line) for comparison and shifted forward in time so that the data becomes superimposed.

FIG. 12 shows directly monitored elution (crosses and rings) from the surface of the chromatography material by EIS. The corresponding UV signal showing the elution peak is obtained by indirect measurement in-line as the product reaches the UV sensor. The derivative of the elution peak becomes a peak that closely resembles the recorded UV sensor output

FIG. 13 shows normalized phase shift of the measured impedance Z as a function of time during the immobilization of a bioproduct to a polymer coated electrode surface within the chromatography unit shown in FIG. 1b, where two different frequency values are shown. At the high frequency, 10 kHz, surface sensitivity of the signal tells the amount of product that has bound and is binding to the electrode surface, while the low frequency signal measures the bulk solution properties, flow of bioproducts through the device.

FIG. 14 shows a comparison of the measurement output of an in-line conductivity sensor plotted as a function of time on a commercial chromatography system compared to the real part of the EIS signal.

FIG. 15 shows direct real-time monitoring of surface specific binding and eluting of a monoclonal antibody sample on a protein A functionalized conductive chromatography material.

FIG. 16 illustrates schematically the steps of a method for real-time monitoring of chromatographic purification of a biological substance.

FIG. 17 illustrates a system of analytical scale EIS chromatography units connected downstream of a preparative chromatography unit where quality critical attributes can be measured in-line.

FIGS. 18a-18c shows an embodiment of the chromatography column in a cross-sectional view. Here the support structure, working electrode, has discrete, physically separated, layers. In FIG. 18b the counter electrode is shaped as a hollow cylinder wrapping around the support structure while being physically separated from it.

FIG. 19a shows a chromatography unit where each discrete layer of the support structure of the chromatography column is connected to a potentiostat capable of handling multiple channels in parallel. In FIG. 19b is shown real-time monitoring by AC signals that produces a signal that can be used to monitor the concentration of biological substances bound to the support structure, and presence of sample in the bulk in real-time during the entire experiment for each discrete layer of the support structure of the support structure/working electrode. FIG. 19c shows the information from each discrete layer of the support structure, which can be used to orchestrate binding and elution of product in a highly optimized and efficient manner i.e. eliminate waste of product, use of solvent, exposure to elution buffers (if used), and desired output concentration.

FIG. 20 schematically shows a time series, vertical direction down, on how elution can be orchestrated using a support structure having multiple distinct layers to optimize elution conditions and provide a real-time in-situ picture of the degree of column loading (0-100%)/n, where n is the number of distinct layers of the support structure.

FIG. 21 schematically shows a support structure with n number of distinct layers during binding where in-situ monitoring is used to track the degree of concentration of biological substance bound throughout the entire support structure in axial resolution, along the direction of flow.

### DETAILED DESCRIPTION

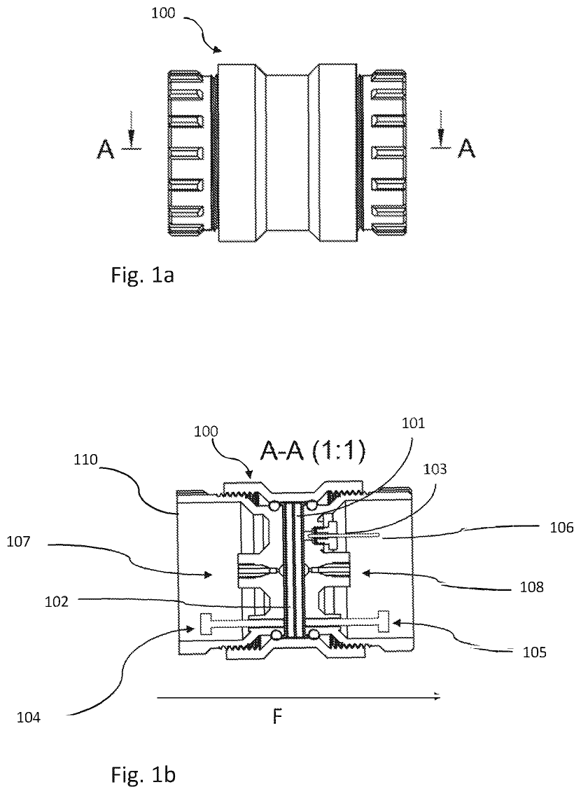

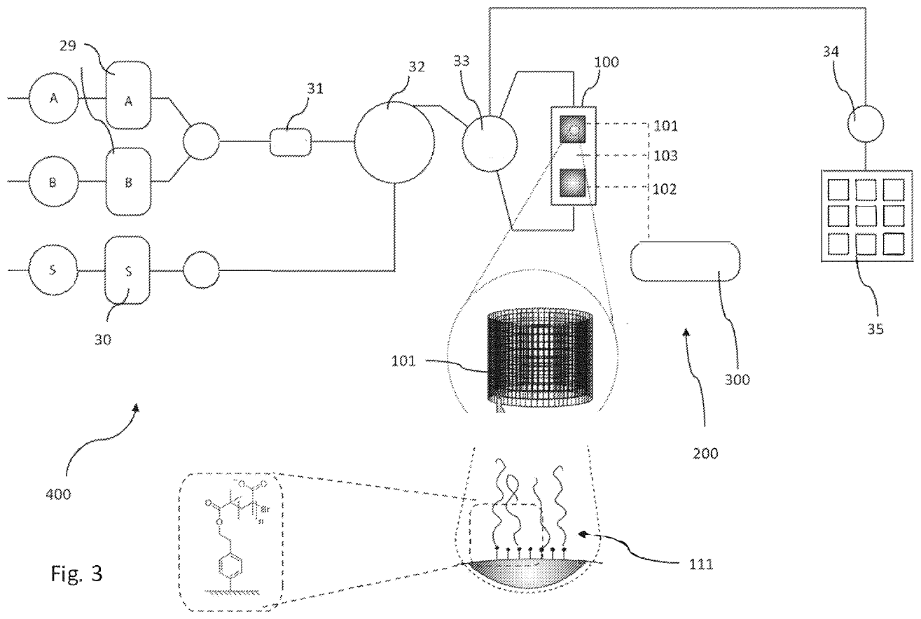

In FIG. 1a and FIG. 1b is shown a chromatography column 100 for use in a chromatography unit 200 and in a chromatography system 400, see FIG. 3. The chromatography column 100 comprises a housing 110 with a multi-electrode arrangement comprising a support structure/working electrode 101, a counter electrode 102, and optionally also a reference electrode 103. The column has external electrical connections 104, 105 and 106 for the working electrode 101, counter electrode 102, and the optional reference electrode 103. The support structure 101 is arranged in the housing 110 in a space between a solution inlet 107 and a solution outlet 108. The working electrode 101 is arranged such that an electrolytic solution arranged to flow, F, from the solution inlet to the solution outlet is contacting at least a portion of the support structure 101. The electrolytic solution is a mobile phase that contains buffer and electrolytes. At least least a portion of a surface of the support structure 101 is electrically conductive. The counter electrode 102 is arranged in the housing 110 and arranged in electrical connection with the support structure 101 via the electrolytic solution arranged to flow from the solution inlet 107 to the solution outlet 108. In a three-electrode set-up the counter electrode 102 and a reference electrode 103 are arranged in the housing 110 and arranged to be in electrical connection with each other and with the support structure 101 via the electrolytic solution.

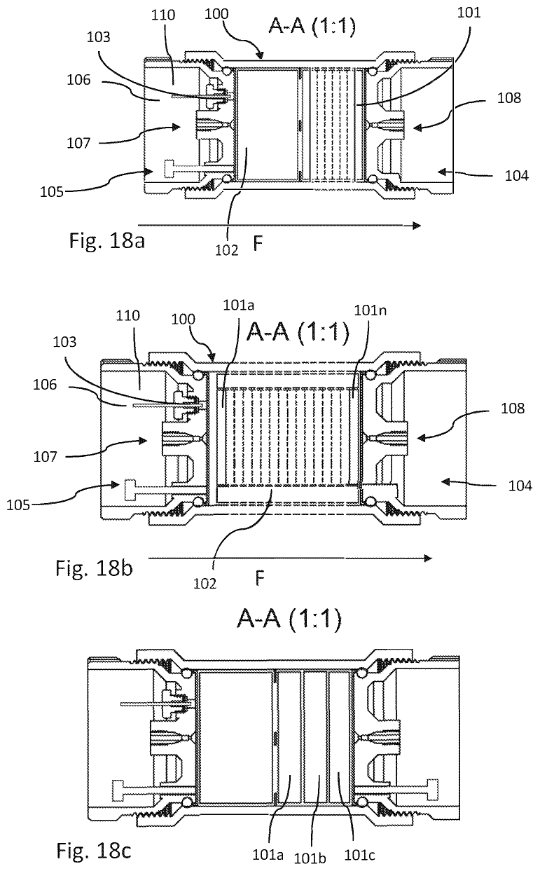

In FIGS. 18a-18c is shown an alternative embodiment of the chromatography column 100. Here the support structure 101 has discrete, physically separated, layers 101a-101n. In FIG. 18b the counter electrode 102 is shaped as a hollow cylinder wrapping around the support structure 101, while being physically separated from it. As can be seen from the figures, an electrolytic solution arranged to flow, F, from the solution inlet 107 to the solution outlet 108 is contacting at least a portion of each discrete layer 101a-101n.

The chromatography unit 200 also comprises a voltage generator 300 arranged to be connected to the electrodes via the external electrical connections 104, 105 and 106.

The voltage generator 300 may, in a two-electrode set-up, be connected to the support structure 101 and to the counter electrode 102, and is arranged to provide an AC voltage signal at a bias between the support structure 101 and the counter electrode 102. The voltage generator 300 may, in a three-electrode set-up, be connected to the support structure 101 and to the counter electrode 102 and the reference electrode 103, and being arranged to provide an AC voltage signal at a bias between the support structure 101 and the reference electrode 103, wherein the counter electrode 102 acts as a current collector. The voltage generator 300 is preferably arranged outside the housing 110.

A recorder 300 is arranged to record a current signal and/or potential signal generated between the support structure 101 and the counter electrode 102 or between the support structure 101 and the reference electrode 103. The voltage generator/recorder 300 may e.g. be a potentiostat or any other instrumentation capable of producing an oscillating AC current across the electrode set-up. The recorder may comprise a display for displaying direct real-time information about the purification process obtained from the recorded current signal and/or potential signal. The recorder may be connected to equipment for controlling flow and fraction collection that enable automation of the purification process based on direct real-time information obtained from analysis of the recorded AC current signal.

For the embodiment shown in FIGS. 18a-18c, the recorder 300 is arranged to record a current signal and/or potential signal generated between each discrete layer 101a-101n, or a majority of the discrete layers 101a-101n, of the support structure and the counter electrode 102 or the reference electrode 103.

This permits independent, and possibly simultaneous, electronic monitoring and control of the discrete layers of the support structure. Signals may be collected in a parallel fashion and simultaneously from all discrete layers, or at least from a majority of the discrete layers, of the support structure. Thereby, a concentration of a biological substance that is bound to the support structure in the different discrete layers can be measured. Thereby, an optimized elution concentration control may be based on features such as maximum eluate concentration. Information about when elution has been completed may be obtained to reduce excessive use of chemicals to elute, or use of shifted bias potential to elute.

At least a portion of a surface of the support structure 101 is provided with a polyelectrolytic coating 111, see FIG. 3. The polyelectrolytic coating 111 is arranged to be switchable between a first state and a second state. In a first state a biological substance to be purified is captured at the support structure and in the second state the captured biological substance is released from the support structure. The molecular features by which the polyelectrolytic coating and the biological substance interacts determines what features determines the first, binding state and the second release state. The first state may be a charged state and the second state may be a neutral state. Alternatively, the first state may be a neutral state and the second state a charged state.

For the embodiment shown in FIGS. 18a-18c, a polyelectrolytic coating may be arranged on at least one of the discrete layers 101a-101n of the support structure 101. In one example, the polyelectrolytic coating on a first discrete layer 101a differs in chemical composition from the polyelectrolytic coating arranged on a second discrete layer 101b. They may have different surface chemical properties such as being provided with affinity ligand, having a hydrophobic exchange chemistry, having an ion-exchange chemistry, etc.

The polyelectrolytic coating may be put in the first state by using an electrolytic running buffer with certain properties/conditions, exposing and equilibrating the coating with the running buffer. The polyelectrolytic coating may be set to the second state by changing the properties/conditions of the running buffer, e.g. by changing pH, salt concentration, addition of a chemical, or changing the temperature, or by adding an elution buffer.

Alternatively, the polyelectrolytic coating 111 may be put in the first state by changing/switching the bias potential difference of the applied AC potential, and be put in the second state by changing/switching the bias potential difference of the applied AC potential. This is, hence, an active electrochemical switching of the polyelectrolytic coating between the first and second states that gives rise to a substantial chemical change on the surface of the support structure and within the polyelectrolytic coating.

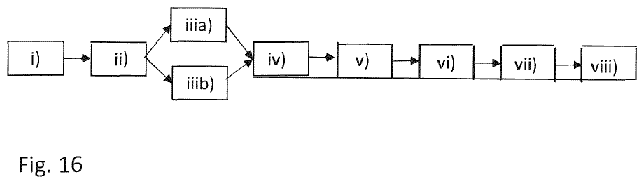

In FIG. 16 is schematically illustrated a method for real-time monitoring of chromatographic purification of a biological substance. In step i) an electrolytic solution volume comprising a biological substance to be purified and contaminant(s) is obtained. In step ii) the chromatography system 400 described above is obtained. Next, there is a step that has two options, in option iiia) an AC potential with a bias potential difference is applied between the support structure 101 and the counter electrode 102, and, optionally, an open circuit potential is first measured between the support structure 101 and the counter electrode 102, where the bias potential is applied against the measured open circuit potential and in option iiib) an AC potential with a bias potential difference is applied between the support structure 101 and the reference electrode 103. In step iv) an electrolytic running buffer is supplied to the housing 110 at the solution inlet 107 of the chromatography column 100, equilibrating the polyelectrolytic coating 111 of the support structure 101 in the electrolytic running buffer. In step v) the polyelectrolytic coating 111 arranged on the support structure is set in its first state. In step vi) the electrolytic solution volume comprising a biological substance to be purified and contaminant(s) is supplied to the housing 110 at the solution inlet 107 of the chromatography column 100, thereby biological substances are captured in the polyelectrolytic coating on the support structure 101. In step vii) the polyelectrolytic coating 111 arranged on the support structure is set in its second state, thereby captured biological substances are released from the support structure 101, and in step viii) a current signal and/or potential signal generated between the support structure 101 and the counter electrode 102 or between the support structure 101 and the reference electrode 103 is recorded during steps iv) to vii).

The method may further comprise a rinsing step after step vi) and a step of collecting biological substances released from the support structure 101 and exiting through the solution outlet 108.

The method may further comprise a step of, based on the recorded current signal and/or potential signal from step viii), provide in real-time: bulk electrolytic solution properties, degree of binding/saturation of the biological substance captured by the polyelectrolytic coating, degree of column loaded with biological substance, potency of the biological substance, concentration of the biological substance captured by the polyelectrolytic coating, pH of the electrolytic solution, and/or conductivity of the electrolytic solution. Such information may then be displayed on a display on the recorder 300 or in direct or indirect connection with the recorder 300. Such information may also be used as decision input for intensification of the manufacturing process by providing real-time instructions to equipment such as pumps, pump valves, fraction collectors for automation of the manufacturing process. The electric signal used to probe events on the surface and in the bulk can be an electrochemical impedance signal, or any modulated electric signal where an alternating potential is applied across the two-electrode/three-electrode system and an alternating current is measured (AC). This kind of measurement is known as electric impedance spectroscopy (EIS). In EIS an alternating current or voltage is applied, centered on a fixed potential value while the resulting alternating current is recorded. The current magnitude is collected as well as the phase shift. EIS is an established technique for analytical scale biosensing. In analytical applications of EIS, boosting the sensitivity is critical. To achieve this, the strategy has been to build electrodes and devices using nanofabrication techniques with highly miniaturized features, like interdigitated electrode patterns and interfaces with nanoscale separation between the electrodes. A challenge of using EIS for biosensing is that the signal transduction mechanism in EIS is poorly understood from a fundamental perspective making associated analysis for extremely sensitive detection highly complex. An important material problem that has prevented EIS from becoming a process analytical technology is that most surface chemistries are incompatible with electrochemistry. For instance, thiol-anchored molecules to surfaces which is standard surface chemistry functionalization of sensors are electro-labile and are easily oxidized and detached from the electrode surface even for small voltages.

By using the above-described chromatography unit 200 in a chromatography system 400 as shown in FIG. 3 there is no need for in-line sensors or off-line sensors to assess if acceptable purity, potency of the biological substance has been reached.

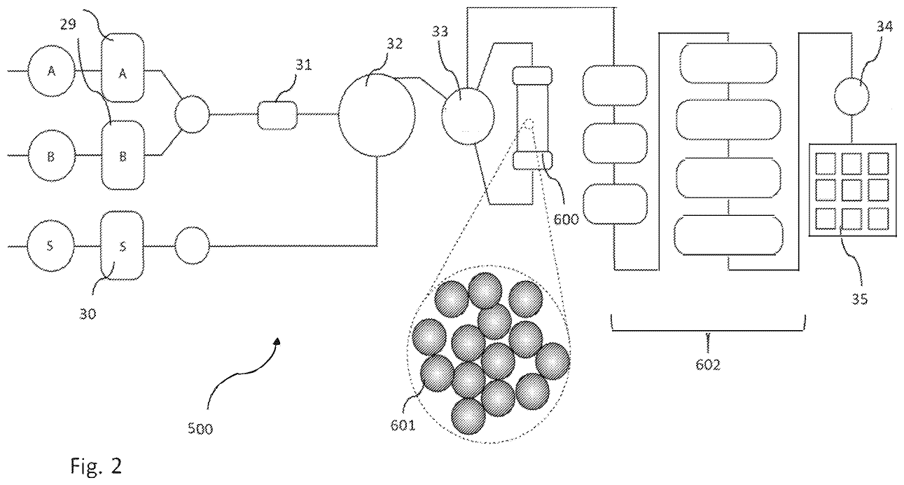

The dominating strategy in conventional chromatographic processes is to build systems as shown in FIG. 2 where different types of sensors are placed in-line, such as UV sensors, with the chromatography column to measure physiochemical properties, such as refractive index, absorbance, conductivity, and the pH of the process flow. A general disadvantage with in-line sensors is that the location of information collection is far away from where the actual purification takes place, on the surface of the chromatography media. The main purpose of these sensors is to monitor the purification process qualitatively and to track the progression of the chromatography cycle, binding, rinsing and elution.

An alternative strategy is to place highly miniaturized sensors in-situ of the chromatography column. These sensors can, however, only sense within a very small volume of the column and the data is not surface specific, meaning it is hard to subtract the background signal from the bulk process liquid, making the quality of information obtained in-situ highly similar to the data obtained in-line.

The chromatography unit 200 described above could be implemented as a fully sensor-free system for purification, or at least as a system that uses minimum amount of in-line sensors to monitor the purification process. The main purification information is obtained in real-time directly on the surface of the chromatography support structure, rather than indirectly by a sensor or system of sensors positioned in-line, or in-situ of the chromatography column. With conventional chromatography systems, quality critical attributes are exclusively measured off-line by technologies like SPR, ELISA, and HPLC. Analytical validation is routinely employed between every unit operation of the purification, starting at the cell culture harvest and until the final processing steps, where at some point the product is cleared, meaning it is of sufficient purity for final formulation.

Off-line analytics is highly resource demanding and contributes substantially to product cost. The assay standards need to be routinely controlled and maintained. Running the protocols and interpretation of the results requires highly skilled and trained staff.

The chromatography system 400 described herein could be implemented as a solution for purification where the decision to clear the product can be taken based on purification data measured directly on the surface of the chromatography support structure by EIS measurements. Hence, the chromatography system described herein may be used to minimize or even replace the need for doing off-line analytical techniques for determining the bioproduct concentration, purity, and potency.

The chromatography unit 200 described may be used for scalable and repeatable separation of analytes in a wide range of quantities (μg to kg) by adjustment of the size of the electrodes 101, 102 (and the area coated with polyelectrolytic coating 111).

The system may measure both surface specific information and bulk solution properties. At certain frequency values, the EIS spectra measures surface specific information, physiochemical information within the polymeric coating, such as but not limited to transfer of charges through the polymer coating, pH on the surface of the material, conductivity on the surface of the material, which may be used to detect binding of target to the surface, presence of process sample and impurities within the coating of the chromatography material. At other frequencies, the EIS signal monitors bulk solution properties, the pH within the column solution, its conductivity, presence of process solution, or of the background buffer.

The chromatography system described herein could be implemented to measure real-time data that represents the entire batch of biopharmaceutical in terms of its binding and elution performance, behaviour, characteristics, data which can be used for determination of quality critical attributes such as the over-all equilibrium binding constant Kd.

Furthermore, the system can be used to measure the concentration of the product in real-time by knowledge of the electrode surface area, its binding capacity which can be used for improved control of elution, dosing and intensify fraction collection.

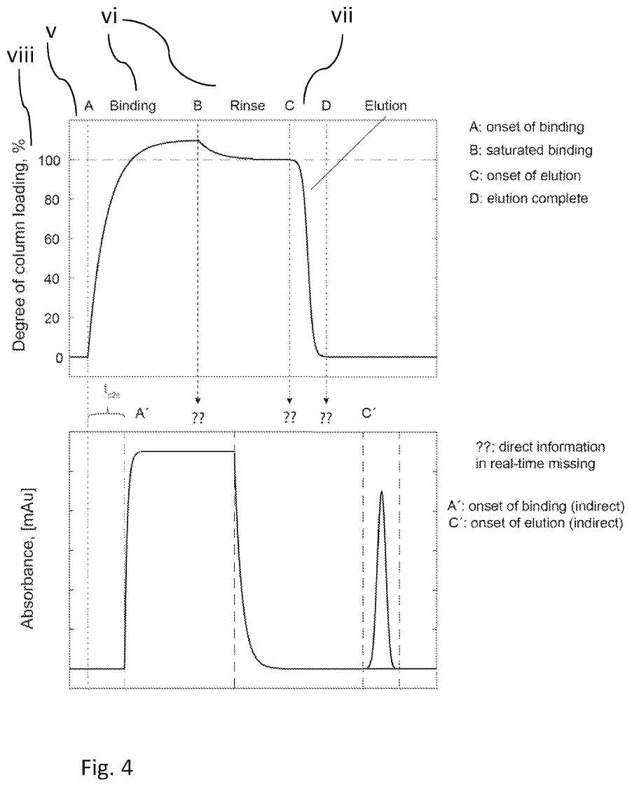

The chromatography system described herein may determine the product flow through the process directly reducing the current time for product to reach the in-line sensors, i.e. eliminates the column-to-sensor delay, tc2s in FIG. 4.

The chromatography system described herein provides information of when exactly in time and volume applied that the column is fully saturated by elimination of the delay tc2s thereby preventing excessive loss of product in the breakthrough. Breakthrough being the point in time during the chromatography cycle where sample and/or product is registered by in-line sensors positioned after the chromatography column.

The chromatography system 400 described herein provides a calibration-free binding capacity determination of the chromatography support material and does not require post-analysis of the elution peaks, off-line complementary analytics, and multiple cycles to characterize the performance in terms of binding capacity.

Furthermore the system reports when rinsing is complete by a reporting a combination of a stabilized dissociation curve, surface sensitive EIS signal, while the bulk solution sensitive signal returns to the background buffer baseline.

The chromatography system herein reports immediately when the elution chemical reaches the surface of the chromatography material.

Furthermore, the system provides an exact measure of the column unloading from beginning 100% loaded to end 0% remaining product bound. The system enables complete reduction of unnecessary or excessive use of elution chemicals.

The chromatography system described herein could be used to minimize the total volume of buffer and water required for a purification cycle by simultaneously tracking the physiochemical properties of the bulk process solution, and the binding of the product to the surface providing a clear cut-off for each step of the purification cycle binding, rinsing, elution, cleaning in place, equilibration.

A chromatography system 400 for real-time monitoring of the purification process is shown in FIG. 3. The system may comprise a liquid management system containing buffer pumps 29, a sample pump 30, a mixer 31, injection valve 32, and column valve 33 for administering the flow path through the device chromatography column 100 followed by an outlet valve 34 connected to a sample fractionation apparatus 35. The device column 100 is connected in-line and it contains the working electrode 101, counter electrode 102, and optionally a reference electrode 103. At least a portion of the working electrode 101, the support structure, is provided with a polyelectrolytic coating 111. The polyelectrolytic coating 111 binds and elutes a biological substance by some intermolecular binding mechanism (affinity, ion-exchange, size, hydrophobic interaction). The working electrode 101, the counter electrode 102, and optionally the reference electrode 103, are connected to a potentiostat 300, which permits real-time direct monitoring of the purification process.

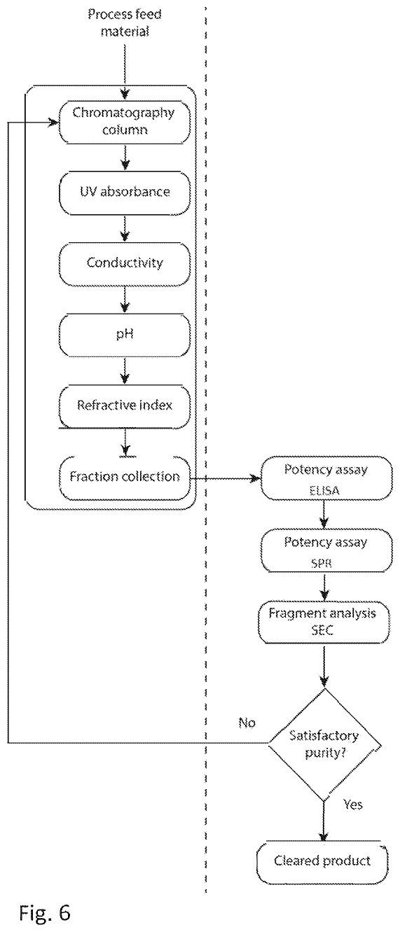

A conventional chromatography system 500 is as shown in FIG. 2 and in FIG. 6 is illustrated an example of the steps taken when purifying a biological substance using such a conventional chromatography system 500. A chromatography column 600 containing non-conductive polymeric beads 601 or a fiber-based membrane. A conventional chromatography system 500 monitors the purification process by a series of in-line sensors 602 devices that measure physiochemical properties of the eluate by pH, UV/Vis, ATR-FTIR, conductivity, fluorescence, refractive index, and light scattering, downstream of the chromatography column 600. In addition to the need of many in-line sensors there is also a need to conduct a large amount of off-line or at-line analysis of the biological substance to understand if the purification has met the required purity and if the product can be cleared.

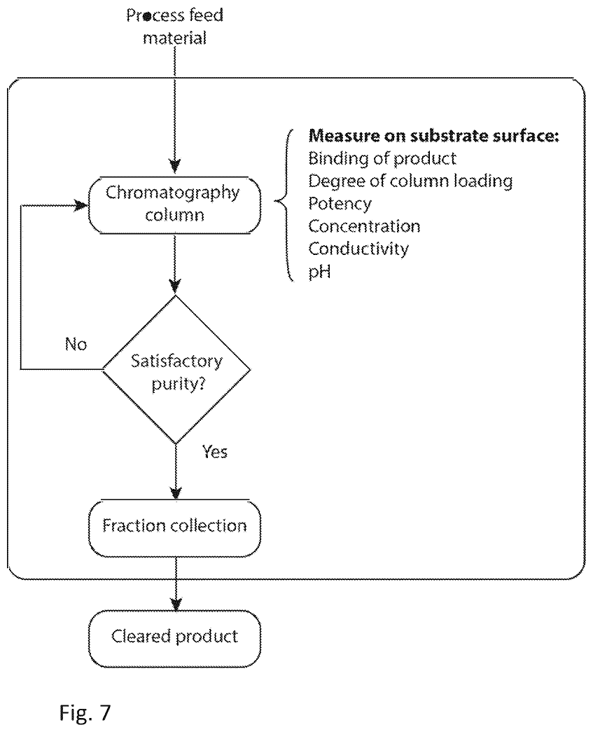

The chromatography system 400 in FIG. 3 reduces the need of in-line sensor equipment for monitoring the purification process by providing in-situ surface specific information of the biological substance binding to the working electrode 101 polyelectrolytic coating 111. In FIG. 7 is illustrated an example of the steps taken when purifying a biological substance using such a chromatography system 400. This chromatography system 400 can quantify directly in real-time the binding of product, degree of column loading, potency concentration, conductivity, pH and presence of the supernatant in the bulk solution within the capsule. The system 400 measures quality critical attributes in-line, as shown in FIG. 7, enabling in-line determination if satisfactory purity of the product has been reached, which reduces the need of off-line analytics and substantially lowers the number and frequency of manual process steps during the downstream purification process.

The conductive chromatography support structure 101 is ideally composed of a highly conductive material, such as a carbon, metal alloy, noble metal or semiconductor surface. Alternatively, an underlying support structure can be non-conductive as long as there is a coating that makes the surface conductive. The conductive chromatography support needs to be physically interconnected to enable EIS monitoring of the entire support surface, ideally in a single piece.

FIG. 4 shows a comparison of data obtained using EIS (upper graph) on a conductive chromatography support structure compared to an in-line UV-sensor placed downstream of a conventional chromatography column 600 (lower graph). During binding, A-B, the biological substance, the product, is detected directly on the entire chromatography surface with EIS, while the UV sensor cannot be used to detect the product since the signal is heavily contaminated from UV absorbing process impurities. The EIS signal can be used for immediate identification of a complete binding curve (upper graph). The UV sensor signal, however, (lower graph) is at this point still saturated, unable to detect saturated binding of product to the column, resulting in a high probability that product is being lost. Point C in FIG. 4 marks the point in time where elution of product begins, which is when the elution buffer reaches the chromatography material, resulting in release of the product/biological substance from the chromatography surface. The true real-time onset of elution can not be obtained using conventional in-line sensors (lower graph), which introduces a risk of using excessive amounts of elution buffer. This is undesirable as the buffer harms the product during a prolonged exposure, and many elution buffers are also a health hazard and environmentally unfriendly e.g. imidazole. At point D in FIG. 4 the finishing of the elution is recorded in real-time again, speeding up the chromatography cycle by immediate feedback on what the state of the polyelectrolytic coating on the working electrode 101 is at any given time point. For the standard workflow for downstream processing, lower graph of FIG. 4, there is an in-line process where a conventional bind-and-elute chromatography unit step is performed, where standard in-line analytical sensors are used to monitor and ensure process stability. To assess the purity after the chromatography unit operation different off-line assays and analytical technologies are conducted to measure quality critical attributes, purity, potency, concentration. The product is cleared if the sufficient purity has been reached, otherwise another purification step by chromatography is employed.

The proposed workflow with the system described herein is simpler compared to conventional downstream processing, where monitoring of the purification process is measured directly within the chromatography column, where there in-line sensors are redundant and where there is ideally no need for off-line analytics.

The support structure 101 used is made of a material that is conductive or semi-conductive. Alternatively, the support structure comprises an electrically conductive and electrically continuous coating. The support structure is interconnected, i.e. it does not comprise a bed of beads, such as of agarose, as in conventional chromatography columns. The support structure or a surface thereof could for example be made of glassy carbon, stainless steel, or gold.

The working electrode 101 may be porous and arranged in the housing such that the electrolytic solution is allowed to flow through the working electrode 101 from the inlet 107 through at least a portion of the working electrode to the outlet 108. With a porous electrode, the solution may be filtered through a micrometer aperture. Thereby, separation of large objects like impurities or aggregates in the solution could be achieved. A micrometer aperture also permits a high surface area, promoting high binding capacity of the biological substance to the working electrode 101.

The working electrode 101 may alternatively be solid, but with a micro structured surface to boost binding capacity, whereby the flow passes in a tangential direction to the electrode surface.

A main direction of extension of the working electrode 101 may be in a direction substantially perpendicular to a flow direction, F, from the solution inlet 107 to the solution outlet 108. The working electrode 101 may have a porosity of 40% to 99%, and an electroactive surface area of the working electrode may be between 100 to 10,000 m²/m³. The porosity may be 40%-99%, or 50-99%, or 60-99%, or 70-99%, or 80-99%, or 50-90%, or 50-80%, or 50-70%, or 50-60%, or 60-80%.

A high porosity, up to 99%, may be obtained by using for example a foam or sponge material for the electrode, and may have 10-100 pores per inch. A porosity of 40% or more may be obtained by using e.g. a mesh electrode. The pore size of the mesh may be 0.01-10 μm. The pores or channels of the working electrode are preferably only open ended and no dead ends.

The electroactive surface area of the working electrode 101 may be between 100 to 10,000 m²/m³, or 500-10,000 m²/m³, or 1,000-10,000 m²/m³.

The counter electrode 102 may be of a porous material that is capable of high current/charge transfer. The counter electrode 102 may be of a different material than the working electrode 101. Alternatively, the working electrode 101 and counter electrode 102 may be made of the same material, in which case it may be preferable if the effective surface area of the counter electrode 102 is at least two times larger than the effective surface area of the working electrode 101 to permit sufficient current capacity of the counter electrode to enable supply of current that allows setting a controlled specified voltage on the working electrode within the entire aqueous potential range ±1.5 V.

The working electrode 101 and the counter electrode 102 are preferably of inert materials that do not undergo permanent chemical changes during exposure to electrolytic solution, or during application of electrochemical signals.

The working electrode 101 and the counter electrode 102 may be arranged in the housing 110 such that the electrolytic solution arranged to flow from the inlet 107 to the outlet 108 first passes through the working electrode 101 and then through or past the counter electrode 102.

The working electrode 101 and the counter electrode 102 may be manufactured and incorporated into the housing 110 in a way that minimizes the void/dead volume in the housing, i.e. minimizes the internal volume of the housing that does not capture any biological substances. By minimizing the void/dead volume in the housing 110, the electrochemical properties of the chromatography column 100 are simultaneously optimized, promoting conditions by which electrochemical release with high concentration of the biological substance can be achieved.

70-100% of the working electrode 101 may overlap with the counter electrode 102, as seen in a plane orthogonal to a direction of flow of the electrolytic solution from the solution inlet 107 towards the solution outlet 108. Thereby, a more efficient electrochemical reaction may be produced on the working electrode. The average distance between the electrodes 101, 102 may be 1 μm to 200 mm. In one embodiment, the average distance is a smaller distance of 1 μm to 20 μm. In another embodiment, the distance may be 1 μm to 200 mm. The electrodes 101, 102 may be held physically apart with a spacer that may have a thickness between 0.01 mm to 0.6 mm, wherein the thickness may be reduced to lower the total column volume while simultaneously making sure that the electrodes do not come in touch with each other. The support structure/working electrode 101 may have a thickness (as measured in the flow direction F) from 1 mm to 100 cm. A thickness of 1 mm to 1 cm is preferably used if the support structure only comprises one discrete layer. A thickness of 1 cm 100 cm can be used when splitting the electrode in one or more distinct physically separated discrete layers 101a-101n. Each discrete layer may have a thickness of 0.05 mm to 10 cm. The thickness and number of discrete layers may depend on the height/thickness of the column used. A distance between two adjacent discrete layers may be 0.01 mm to 1 cm. If the distance between two adjacent discrete layers is larger, an empty space is created between the layers that may dilute the product and consume liquid. Hence, the discrete layers should preferably be arranged as close as they can get without them touching each other and starting to conduct current.

The chromatography unit 100 may further comprise a reference electrode 103 arranged in the housing 110 and arranged for electrical connection through the electrolytic solution with the working electrode 101 and the counter electrode 102. The reference electrode 103 may have a stable and well-known electrode potential and it is used as a point of reference for the potential control and measurement. The working and counter electrodes may be arranged in the same electrolytic solution, and the reference electrode may be arranged in a separate tube containing a reference solution. The reference electrode may be made of a silver wire with a silver chloride coating (AgCl) or an electrode e.g. a carbon electrode coated with silver particles with an AgCl coating where the reference electrode is either directly exposed to the analyte solution, or it is separated by a semipermeable membrane through which ions can be transported but not the analyte or other molecules present in the analyte solution. For a reference electrode shielded by a semipermeable membrane the reference electrode solution used was 3M potassium chloride (KCl), which also it the solution used for storing the AgCl reference electrode. The reference electrode can in principle be any electrode with a stable and well-known reference electrode potential e.g. standard hydrogen electrode, saturated calomel electrode or a copper sulphate electrode. The working electrode, counter electrode and reference electrode preferably are manufactured and are composed of materials such that they do not actively or passively leach elements and compounds that are harmful for the downstream process, e.g. metal ions, radicals, and other compounds that may react with the analyte.

The reference electrode 103 may be arranged at an average distance of 1-50 mm from the counter electrode 102 and at an average distance of 1-50 mm from the working electrode 101. The average distance may be 1-50 mm, 1-300 mm, 1-20 mm, 1-10 mm, 1-5 mm, 5-30 mm, 10-20 or 5-10 mm from the counter electrode and the working electrode respectively. The purpose of the reference electrode 103 is to have an inert and well known reference point, where a minimal current passes through the reference electrode 103 but where a potential difference between the working electrode 101 and the counter electrode 102 can be reliably specified.

The chromatography support structure 101, or at least a surface thereof, is provided/coated/functionalized with a polymer coating 111 anchored to the support structure, see FIG. 3. The coating is a polyelectrolytic coating compatible with electrochemistry. If the working electrode 101 is porous, the polyelectrolytic coating 111 may also extend into the pores of the electrode. The coating can withstand electrochemical potentials of +/−2 V without degradation, making the working electrode capable of multiple-use/multiple chromatographic cycles.

An average thickness of the polyelectrolytic coating 111 provided on the working electrode 101 may be 1 nm-1 μm, but preferably 10-50 nm, or 10-40 nm, or 10-30 nm, or 20-50 nm, or 20-40 nm, or 20-30 nm. The polyelectrolytic coating may be in the form of a polyelectrolyte brush, a film, a gel, or layer.

The polyelectrolytic coating may be covalently bound to the working electrode and may comprise a pH-responsive polymer covalently bound to the surface of the electrode through a monolayer of electrochemically insensitive aryl bonds, such as for instance through diazonium salt surface functionalization.

The electrochemically stable chemical anchor, i.e. the electrochemically insensitive bond comprising an aryl, enables monitoring by EIS with a wide range of bias potentials+/−2V and tunable release of the captured substance by electrochemistry. Due to these electrochemically stable aryl bonds, the chromatography column 100 and the polyelectrolytic coating on the working electrode 101 can be reused a large number of times. Furthermore, the polymeric coating 111 of the chromatography support material 101 can have different functionalization that enable different modes of chromatography. For instance, it could be an anionic polyelectrolytic coating, such as polymethacrylic acid, in which case the column 100 could be used for cationic exchange chromatography. It could be a cationic polyelectrolytic coating, such as poly(dimethylamino methacrylate), in which case the column 100 could be used in anionic exchange chromatography.

The pH-responsive polymers may be e.g. polymers comprising carboxylic acid groups, which have the ability to dissociate protons, or to uptake protons, as a result of the pH increasing or decreasing at the interface of the electrode. The pH-responsive polymers may be for example a poly(acrylic acid) (PAA) or a poly(methacrylic acid) (PMAA). The pH-responsive polymer may be a polymer functionalized with a pH-responsive and analyte-specific ligand.

The polymer, for example a polymer comprising carboxylic acid groups as discussed above, or other kinds of polymers e.g. poly(glycidyl methacrylate), poly(2-hydroxyethyl methacrylate), heparin, hyaluronic acid, dextran, can be modified/functionalized to contain functional groups that are pH-responsive and have affinity for the analyte of interest. In some cases, the polymer is functionalized with a molecule with several functional groups that creates a “handle” for gripping specific substances/analytes in the electrolytic solution. Such handles can be analyte-binding at one pH and be analyte-repellent in another state.

The side group of the monomer (repeat group of the polymer) may contain a functional group that can for example be used as a linker, such as carboxylic acids, epoxy groups, glycidyl functional groups, or 2-hydroxyethyl groups, to which linker an enzyme, nitrilotriacetic acid-metal ion2+ (NTA-Me2+), protein A, protein G, calmodulin, streptavidin etc. may be immobilized. Thereby, the polymer may be functionalized with an analyte-specific ligand being an enzyme, NTA-Me2+, protein A, protein G, calmodulin, or streptavidin.

The polyelectric coating 111 may have features and characteristics and may be produced as described in WO2021/107836, which hereby is incorporated by reference.

For electrochemically activated elution, the application of a bias potential difference between the working electrode 101 and the counter electrode 102, a local microscale pH gradient is created that extends from the surface of the working electrode. The pH-sensitive/responsive polymer switches its state as a result of the local pH difference on the surface. The switch of the pH sensitive/responsive polymer results in either capture or release of the substance/analyte from the surface of the electrode, which gives rise to a separation between the substance/analyte and other components in the electrolytic solution. The separation takes place due to a differing affinity towards the electrode for the analyte compared to other components in the electrolytic solution. The difference in affinity comprises non-electrostatic intermolecular attractions, e.g. hydrogen bonding between the analyte and the polymer-coated electrode. Further, it may be due to electrostatic attraction or repulsion. Thereby, it is possible to separate and eluate a purified substance from the chromatography column 100.

The polymeric coating provides a chromatography column, which have the same capabilities as current chromatography materials in terms of immobilization of biological substances/products by different mechanisms, affinity, ion-exchange, ion-pairing, hydrophobic interactions, size exclusion.

The biological substance, analyte, to be purified from other substances and/or contaminants in the electrolytic solution may be an oligonucleotide, a protein, a gene vector, a lipid nanoparticle, liposome, a carbohydrate, a glycosylated biomolecule, a protein pharmaceutical a therapeutic protein, a vesicle, an oligonucleotide, a glycan, a greater biological entity such as a cell or a virus capsid, or a combination product such but not limited to a protein-DNA conjugate, or hydrogen bonding macromolecule of synthetic or biological origin provided in an electrolytic solution comprising other components such as other biomolecules and/or chemicals.

If the substance/analyte is a protein or a construction predominantly composed of proteins or lipids, like a virus particle or an exosome, the analyte is captured in the polyelectrolytic coating in a neutral state through non-electrostatic binding, e.g. hydrogen bonds, and in a charged state the captured analyte is released from the polyelectrolytic coating by electrostatic repulsion. Conversely, if the analyte is a carbohydrate or oligonucleotide the analyte is captured to the polyelectrolytic coating in the first, charged state followed by release upon a switch to the second, neutral state. If the analyte is a fusion of two different kinds of biomolecules, for example an antibody conjugated to an oligonucleotide, either mode of capture and release is possible, which will be practical to use depends on which of part of the molecule dominates the interaction. Finally, if the polyelectrolytic coating is post-functionalized with a biological ligand molecule the physiochemical binding characteristic of the ligand-biomolecule pair as a function of pH will dictate the condition for capture and release.

High amounts (multilayers) of proteins may be spontaneously immobilized in their native state by non-electrostatic intramolecular attractive interactions e.g. hydrogen bonding, to the polyelectrolytic coating when in its neutral, protonated state. The proteins are irreversibly bound in/to the polyelectrolytic coating granted that the polyelectrolytic coating stays in its neutral state with preserved structure and catalytic function. When changed to its second, charged state the biological substance/analyte is repelled/eluted from the coating and may be collected.

The electrolytic solution is a solution that generally contains ions, atoms or molecules that have lost or gained electrons, and is electrically conductive. The electrolytic solution is preferably entirely free from chemicals that trigger elution of the substance/analyte from the support structure. Such electrolytic solution may for example be a cell culture medium, buffer solution etc. The electrolyte is composed of a buffering species, everything from 1 mM (extremely low), to physiological buffer concentrations of 100 mM and up to 1 M may work. Salt, ions, needs to be in the electrolyte as carrier of charges. The total salt concentration, the ionic strength, will influence the pKa of the polyelectrolytic coating. A high salt concentration leads to high pka and a low salt concentration leads to low pKa, changing the pivot point between the first (neutral) stage and the second (charged state)—meaning the pH at which point the polyelectrolytic coating is analyte binding and repelling.

To enable electrochemical reactions, the electrolytic solution comprises redox-active species. Such redox-active species may either be inherently present in the electrolytic solution, e.g. oxygen, or glucose, or may be added to the electrolytic solution, e.g. hydroquinone, hydrogen peroxide, dopamine hydrochloride (DOPA), ascorbic acid, 4-aminophenethyl alcohol (tyrosol), 3,4-dihydroxyphenetylacetic acid (DOPAC), β-nicotinamide adenine dinucleotide, oxygen and reduced disodium salt hydrate (NADH).

A redox-active species should be present to be able to switch the polyelectrolytic coating from the charged, high surface pH state to the neutral, low surface pH state. To switch between the neutral and charged state, redox-active species are present in the solution in the form of oxygen.

The working electrode 101 has the ability to produce a pH gradient extending at least 5 micrometers away from the working electrode surface by electrocatalytical reaction with a reducing agent where the concentration of the reducing agent ranges from 1 nM to 100 mM.

The voltage generator 300 is arranged to be connected to the support structure 101 and to the counter electrode 102 and to provide a potential difference between the support structure and the counter electrode, thereby putting the polyelectrolytic coating in a first state, allowing the biological substance to be purified to be captured by the working electrode. When switching the potential between the electrodes, by means of the voltage generator, captured substance is released/eluted from the working electrode as the polyelectrolytic coating is changed into a second state, exits the chromatography column 100 through the solution outlet 108 and can be collected.

Elution, release, of bound analyte to the working electrode 101 can be achieved by applying a potential difference, an electrochemical signal, that alters the surface pH and thereby the intermolecular interactions between the polyelectrolytic coating 111 on the working electrode and the bound analyte/substance.

The electrochemical potential produces a local pH gradient that disrupts a specific interaction between resulting in elution without changing the solution pH of the device.

In one method favourable binding conditions are achieved at neutral pH to slightly basic pH e.g. pH 7-8, by introduction of the analyte to a functionalized polyelectrolytic coating, where immediate binding between a highly specific ligands occurs.

By changing the ionic concentration of the electrolytic solution you can change the pKa of the polyelectrolytic coating, and thereby change the conditions for attractive and repulsive interactions between the analyte and the polyelectrolytic coating. This can be used to change the pH at which analytes spontaneously bind to the polyelectrolytic coating. For instance, at lower total salt concentrations the pKa of polyacidic coatings composed of carboxylic acids is raised to neutral pH, allowing capture of biomolecules to occur at neutral pH instead of a slightly acidic pH.

In one method the total salt concentration and buffer capacity of the electrolytic solution is low, enabling highly sensitive switching of the interface pH by application of very small currents (<100 μA) and potentials (+100 mV).

The method may comprise a step before supplying the electrolytic solution comprising the biological substance/analyte to the column 100 of running a buffer through the column, the running buffer having a pH between pH 5 to pH 7.5.

The pH is chosen based on the preferred choice of buffer for the analyte in combination with at which specific pH and solution composition the analyte binds spontaneously to the electrode.

The buffer is used as a background buffer to equilibrate the system at the selected pH and salt concentration where separation is to be conducted. The running buffer does not bind to the working electrode 101. Analyte interactions are favoured, resulting in binding of said analyte to the working electrode of the device.

The running buffer used is a buffer that does not comprise any chemical species that may be harmful to the analyte, cause degradation, be of environmental concern or add significantly to the process cost. Examples of such running buffers and concentrations of such buffers are imidazole 500 mM, highly acidic buffers e.g. pH 2-3 100 mM acetic acid buffers or 0.1 M glycine x HCl pH 2-3, sodium hydroxide 0.5 M, organic surfactants and organic solvents such as ethylene glycol, glycerol, PEG, amino acids, sodium alkyl sulphate.

The electrolytic solution comprising the substance may be supplied at the solution inlet at a flow rate of 0 mL/min to 10 L/min. Thereby providing sufficient residence time for efficient binding of substance to the polyelectrolytic coating 111 of the working electrode 101, while allowing the entire substance sample to flow through the column 100 to maximize uptake.

After the step of allowing the electrolytic solution to flow from the inlet 107 to the outlet 108 such that the substance/analyte is captured by the polyelectrolytic coating 111 arranged on the working electrode 101, the column 100 may be rinsed to remove unbound analytes and other components in the solution from the interior volume of the column.

The following details a method description for how a changed bias potential of the EIS measurement during the elution step can be used to actively produce an electrochemically induced pH gradient on the interface of the support structure. The step of setting the polyelectrolytic coating arranged on the support structure in its second state by changing/switching the bias potential difference of the applied AC potential, thereby eluting the biological substance/analyte from the working electrode, may comprise applying a constant potential difference over time where the duration may be 1 second to 3600 seconds. It may be 1-10 seconds, 10 to 30 seconds, 30-60 seconds, 60-120 seconds, or 120 to 300 seconds, or 300 to 600 seconds, it may also be 600 to 3600 seconds long.

Thereby a pH gradient is established. The extent of the pH gradient is primarily determined by (i) the buffer capacity of the solution, which counteracts the electrochemical reaction that alters the surface pH, and (ii) the magnitude of the electrochemical potential which determines the rate of the electrochemical reaction on the surface, (iii) the concentration of electroactive species i.e. proton accepting, or proton donating species, (iv) the flow rate renewal of buffer and mass-transfer properties diffusion and convection through the device. The constant potential difference applied may be a positive or negative potential with a magnitude between 0 V and 1.5 V.

The potential difference is applied in the presence of a redox species that can produce or consume protons to change the pH.

The potential is positive if the intention is to lower the pH on the surface of the electrode, the potential is negative if the intention is to increase the pH on the surface.

Applying a potential difference between the working electrode 101 and the counter electrode 102, thereby eluting the biological substance/analyte from the working electrode, may comprise varying the potential difference continuously between two potential values over time where the duration may be 1 second to 600 seconds. It may be 1-10 seconds, 10 to 30 seconds, 30-60 seconds, 60-120 seconds, or 120 to 300 seconds, or 300 to 600 seconds, it may also be 600 to 3600 seconds long.

Application of a variable electrochemical potential will establish a variable pH gradient, where in addition to the above-mentioned effects the rate of potential change will affect the extension of the pH gradient and result in a temporal variation in the change of the surface pH. The variable potential may be a step-wise increasing potential difference, resulting in a step-increase in pH that produces net-electrostatic repulsion between the electrode and the analyte. The potential difference applied may be continuously varied between two positive or negative voltage values within the magnitude range of 0 V to 1.5 V and for a duration between 1 to 3600 seconds.

The duration may be 1 second to 600 seconds. It may be 1-10 seconds, 10 to 30 seconds, 30-60 seconds, 60-120 seconds, or 120 to 300 seconds, or 300 to 600 seconds, it may also be 600 to 3600 seconds long.

The selected potential window between which the voltage is varied may vary depending on which redox active species is present in the electrolytic solution that alters the electrode surface pH. The local pH on the surface may be measured using analytical techniques to connect the potential window and voltage values used with the actual pH produced on the surface.

Providing a variable potential difference and providing a constant potential difference may be combined for eluting an analyte. For example, a varied potential may be used initially, followed by a constant potential difference.

By varying the potential difference continuously and at different speeds, as compared to just applying a potential suddenly, a separation with higher resolution can be obtained and you can gradually separate analytes as the interaction with the polyelectrolytic coating changes.

By varying the potential, it is possible to selectively desorb certain analytes such as virus capsids filled with genetic material, from empty virus capsids or partially empty virus capsids, and from host-cell proteins.

The resolution for separation of analytes by their difference in isoelectric point may be as low as 0.4 pH units, which is the isoelectric point difference for separation between filled and empty virus capsids.

By application of a potential where biomolecules with a certain isoelectric point are unbound from the polymer surface, the remaining analyte molecules are separated from biomolecule impurities and other impurities that may be present in the electrolytic solution.

By use of an electrochemical signal, it is possible to instantaneously release all/a majority of analytes bound to the working electrode, increasing the concentration of the separated pure analyte sample from a dilute sample.

With one electrochemical signal it is then possible to increase the concentration of the analyte sample by at least 20 times.

Sample retention, the amount of bound analyte that is recovered by electrochemical signal was measured may be up to but not limited to 94%.

The solution exiting the outlet may be collected in fractions. This solution comprises fractions of different components. Depending on the voltage applied, different analytes are eluted from the chromatography column.

The system may further comprise a solution analysis device arranged to analyse the content of the solution collected at the solution outlet. The solution analysis device may for example comprise a UV analyser, a fluorescence detection analyser, or analysis may be performed by sodium dodecyl sulphate-polyacrylamide gel electrophoresis (SDS-PAGE), Enzyme Linked Immunosorbent Assay (ELISA), Real-time polymerase chain reaction (qPCR) or other analytics assays.

In the experimental section below is described a specific example of providing a chromatography column 100 and chromatography unit 200 with a working electrode provided with a specific polyelectrolytic coating 111. Other polyelectrolytic coatings that could be used in the chromatography column 100 may have characteristics and may be produced as described in WO2021/107836, which hereby is incorporated by reference.

### Experimental

### Chemicals

All chemicals were purchased from Sigma-Aldrich unless stated otherwise. H2O2 (30%) and NH4OH (28-30%) were from ACROS, while H2SO4 (98%) and ethanol (99.5%) were from SOLVECO. Water was ASTM research grade Type 1 ultrafiltered water (milli-Q-water). Chemicals used for the synthesis of diazonium salt 1 were 4-aminophenethyl alcohol, tetrafluoroboric acid (48% solution in water), acetonitrile, tert-butyl nitrate, and diethyl ether. For attaching diazonium salt to gold, L-ascorbic acid was used in water. When converting the diazonium monolayer into a polymerization initiator layer, dichloromethane, triethylamine, and α-bromoisobutyryl bromide were used. The chemicals employed in polymerization were tert-butyl acrylate, tert-butyl methacrylate, dimethylsulfoxide, dichloromethane, methane sulfonic acid, N,N,N′,N″-pentamethyldiethylenetriamine (PMDTA), CuBr2 and L-ascorbic acid.

For post modification of brushes after synthesis 1-ethyl-3-8 (3-dimethylaminopropyl) carbodiimide hydrochloride (EDC), N-hydroxysuccinimide (NHS).

Buffers used in this work were based on phosphate buffered saline (PBS) tablets (0.01 M phosphate, 0.13 M NaCl, pH 7.4), disodium hydrogen phosphate and NaCl, or tris(hydroxymethyl)aminomethane (TRIS) titrated to a specific pH with HCl (1 M aqueous solution) or NaOH (1 M aqueous solution).

Biological compounds used were protein A (Medicago), monoclonal antibodies and immunoglobulins (Sigma Aldrich).

### Materials

Stainless steel (316L) meshes with 1, 5 and 10 micrometer in aperture was used as starting material for the working and counter electrodes. A thin gold coating was prepared on the working electrodes by electron-beam physical vapour deposition (Lesker PVD 225) of gold (50 nm). A 1 nm titanium dioxide layer was used as the adhesion layer. Prior to the deposition the meshes were rinsed in isopropanol and dried in N₂. Silver wires were used to prepare reference electrodes. AgCl reference electrodes were prepared by immersion of the silver wire into 10× diluted HCl (37%) with ultrapure water.

### Preparation of Diazonium Salt

Diazonium salt was synthesized using a modified procedure from a previous report (S. Gam-Derouich et al., Aryl diazonium salt surface chemistry and ATRP for the preparation of molecularly imprinted polymer grafts on gold substrates. Surface and Interface Analysis 42, 1050-1056 (2010)). Under an inert atmosphere, 4-aminophenethyl alcohol (2.94 g, 20 mmol) and tetrafluoroboric acid (9.94 g, 113 mmol) were dissolved in acetonitrile (20 mL). In a separate flask, tert-butyl nitrate (2.269 g, 22 mmol) was dissolved in acetonitrile (12 mL). Both solutions were degassed and cooled to −20° C. alongside 200 ml of diethyl ether.

After 20 min the solutions were warmed to 0° C., before the tert-butyl nitrate solution was added to the 4-aminophenethyl alcohol solution dropwise with stirring. The reaction was then stirred for a further 1 h. The reaction was terminated by dropwise addition of the dark yellow solution to rapidly stirring diethyl ether (200 mL). After additional stirring for 1 h the supernatant was decanted off. The brown colored precipitate was dried and 3.69 g of impure diazonium salt was obtained.

To verify the product, 1H NMR spectra were recorded at ambient temperature on a Varian 400 MHz NMR spectrometer. Spectra were analysed relative to external TMS and were referenced to the most downfield residual solvent resonance (CDCl3: δH 7.26 ppm). ¹H NMR resonances of the diazonium salt matched those previously reported (S. Gam-Derouich et al., Aryl diazonium salt surface chemistry and ATRP for the preparation of molecularly imprinted polymer grafts on gold substrates. Surface and Interface Analysis 42, 1050-1056 (2010)) and analysis revealed a purity of 80%.

### Polymerization Initiator on Electrode Surface

Stainless steel meshes were placed in a glass jar with a septum seal containing diazonium salt (0.301 g, 1.28 mmol) and the jar was purged with N2. In a separate flask, ascorbic acid (0.028 g, 0.16 mmol) was dissolved in water (40 mL) and the solution was degassed for 1 h. Then, the ascorbic acid solution was transferred into the sealed glass jar causing dissolution of the diazonium salt. The gold surfaces were stirred in the solution for 1 h by use of a platform shaker (nitrogen bubbles that appear on the surface after 15 min indicate successful diazonium salt monolayer formation), after which they were thoroughly rinsed in water then ethanol, and dried.

To convert the diazonium monolayer, the monolayer is illustrated in FIG. 3, into a polymerization initiator layer, the gold surfaces were exposed to α-bromoisobutyryl bromide (0.222 mL, 1.80 mmol) and triethylamine (0.302 mL, 2.17 mmol) in dichloromethane (20 mL) for 10 minutes, after which surfaces were rinsed in ethanol and dried under N2.

### Synthesis of Polymer Coating on Electrodes

SI-ATRP (surface initiated activator-regenerated atom transfer radical polymerization) was used to prepare poly(acrylic acid) (PAA) polymer brushes, see FIG. 3, i.e. the polyelectrolytic coating 111, in a manner similar to published procedures (G. Ferrand-Drake del Castillo, G. Emilsson, A. Dahlin, Quantitative analysis of thickness and pH actuation of weak polyelectrolyte brushes. J Phys Chem C 122, 27516-27527 (2018)).

Inhibitor was removed from the monomer tert-butyl acrylate (TBA) using an alumina column, after which it were stored at −20° C., then warmed to room temperature immediately before use. Reactions were carried out using standard Schlenk line techniques under an inert atmosphere of N2. CuBr2 (0.006 g, 0.03 mmol), and pentamethyldiethylenetriamine (PMDTA), (0.056 mL, 0.276 mmol) were dissolved in dimethyl sulfoxide (20 mL) and, alongside a separate flask of tert-butyl acrylate (20 mL, 0.1378 mol), was deoxygenated via vigorous bubbling of N2 for 30 min.

The reaction solution and monomer were then transferred via cannula into a screw-top jar (with rubber septa lid) containing initiator-prepared gold surfaces. The reaction was initiated by the addition of ascorbic acid (0.049 g, 0.276 mmol). The final concentrations of each component in the reaction medium were: [monomer]=3.4 M, [CuBr2]=1.1 mM, [PMDTA]=11.0 mM, and [ascorbic acid]=11.0 mM. The reaction was placed under magnetic stirring. Reactions were quenched by immersing the samples in pure ethanol. Poly(tert-butyl acrylate) (PTBA) brushes were then converted to PAA by exposure to 0.2 mM methane sulfonic acid in dichloromethane (10 mL) for 15 min, followed by rinsing in dichloromethane and ethanol. The electrodes were dried in N2 and stored in dry conditions until further use.

Post-Functionalization with Biological Ligand on Polymer Coating

PAA was post-modified by EDC/NHS coupling technique for attachment of protein A to the polymer brush. The electrode surface was exposed to a water solution with 50 mM EDC and 50 mM NHS for 30 minutes followed by rinsing in water. A protein A solution 0.3 g/L with pH 7.4 was used for immobilization of protein A to the electrode surface for one hour followed by rinsing in PBS and water. The electrodes were stored in water and at 2-8 C after the post-functionalization.

### Manufacturing and Assembly of a the Capsule Device Containing Electrodes

Three-dimensional models of the chromatography column, see FIG. 1a and FIG. 1b, were designed in CAD software (Autodesk Fusion 360). The prototype was sliced in PrusaSlicer (Prusa3D) and printed on a MK3S 3D-printer (Prusa3D) using poly(ethylene terephthalate glycol) (PETG) or polypropylene (PP) filament using print settings (0.1 mm layer height, 5-6 wall layers, 5% extrusion multiplier, 100% fill density) to make the device resistant to leakage.

The column was assembled as shown in FIG. 1b, by threading a centre body piece onto an inlet body piece. The reference electrode 103 was connected to the inlet body piece. The counter electrode 102 was placed on the internal surface of the inlet body piece, after which a spacer and an o-ring were positioned above the counter electrode 102 such that the o-ring has full contact with the inlet body piece creating a fluid resistant seal. The working electrode 101 placed lying on the spacer element disc and the outlet body piece was connected by threading it into the centre piece. Connector pins 104 and 105 for the working and counter electrode comprising metal screws in stainless steel were threaded onto respective inlet ports until they made contact with respective electrode. This was verified in dry conditions with a multimeter prior to installation on the chromatography system.

### Chromatography System Settings

Sample solution of pure IgG, 0.5 mg/mL, and a 1 mL total sample volume was injected on a chromatography system AKTA Explorer. The flow rate used was 0.25 ml/min throughout the entire experiment, the injection loop was emptied with a total volume of 6 mL running buffer. The running buffer (A) used was 1 mM phosphate and 10 mM NaCl pH 7.0. The elution buffer (B) used as pH 2.5 1 mM phosphate and 10 mM NaCl. A step injection of the elution buffer with a total of 10 mL was used to elute bound IgG from the electrode surface.

### Electrochemical Impedance Spectroscopy (EIS) Measurements

Potentiostatic EIS measurements were performed using a potentiostat Gamry 1010E (Gamry Instruments) with EIS capability. Representative EIS settings used were a bias potential of −0.2 V, with respect to either the E reference or the E open circuit potential. The AC amplitude was 10 mV. The complete frequency window investigated was 1e6 to 20 Hz. The specific frequency window was adjusted for different measurements. The total measurement of a wide frequency window took approximately 1 minute. Smaller intervals or even single frequencies were measured to increase the measurement cadence in some cases. When the bias potential was measured against the open circuit potential an initial delay period where the open circuit potential (OCP) was measured prior to initialization of EIS measurement.

For passive monitoring of the binding process the bias potential was chosen at a value where no electrochemical reactions occur at a significant rate that will alter the interface pH of the support structure. Lack of altered pH change ensures that the EIS scan is passive and will not interfere with binding or release.

For active electrochemistry in combination with EIS monitoring of the support structure. Electrochemical elution is produced by changing the bias potential to a value where significant interface pH change can be expected, such as for instance-1 V against AgCl.

The EIS measurements were performed prior to the start of the chromatography bind and elute cycle to verify steady state conditions and an equilibrated signal while just flowing buffer liquid. When stable baseline conditions were met, the chromatography bind-and-elute cycle was initiated on the chromatography system and EIS scans were collected during the sample application, column wash, elution and equilibration steps.

Different methods of measuring the degree of column loading and unloading electrically were used to demonstrate and quantify surface specific binding to the surface:
(1) In the simplest approach the floating open circuit potential was used to track binding to the working electrode surface, no AC signal and no EIS measurement applied. This method of measuring was highly sensitive to disturbances.
(2) A second, more robust approach was to measure the impedance signals for a range of different frequencies (20-1e6 Hz), where the impedance Z(ω), its real component Re(Z), imaginary component im(Z), Modulus Mod(Z), Phase angle Pha(Z), Vdc were recorded for each frequency value.
(3) A third option was to measure the binding process at a single or a few selected frequency values with very high data acquisition rates in order to capture the process of binding of biopharmaceutical with high resolution (ms).

### Analysis of the EIS Measurements

For OCP based method the column loading and unloading is directly measured with the OCP signal as a function of time throughout the column purification cycle.

When EIS was used the impedance signal at any given time of the chromatography cycle was either analyzed with a real and imaginary part where the Re(Z) was sensitive to the conductivity and Im(Z) was sensitive to the surface loading of the electrode of biomolecular product.

Z(ω)=Zre(ω)+jZim(ω)=Mod(Z)*e(jwt); where w=2pif, and where j=sqrt(−1)

Another method was to use polar representation of the EIS signal where the modulus Mod(Z) and the phase angle Arg (Z) at a specified frequency was studied as a function of time throughout the chromatography experiment. For visualization purposes where the relative column loading is shown the real and imaginary part of the measured impedance signal were normalized between 0 and 1.

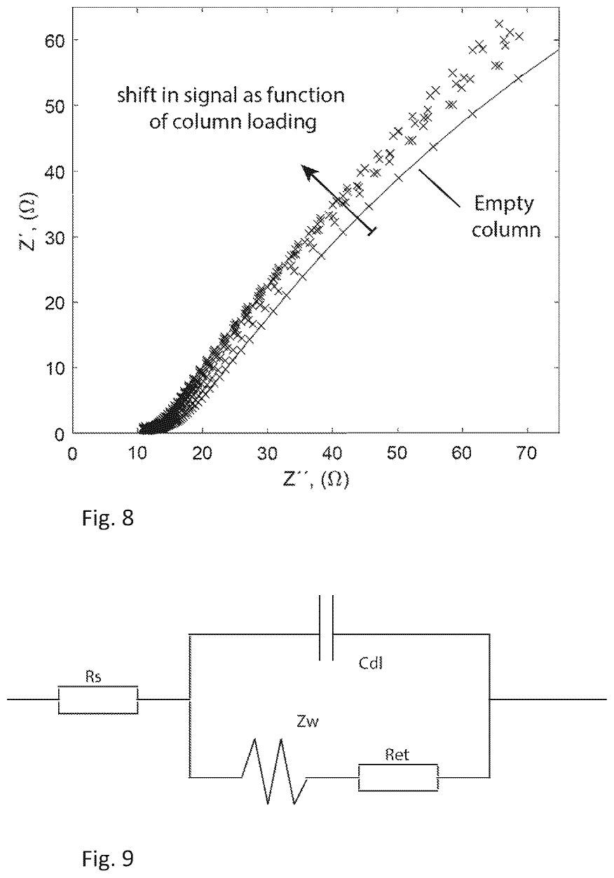

Yet another method was to plot a Nyquist diagram where Re(Z) is plotted as function of −Im(Z) and where the relative position in the plot with respect to time throughout the purification cycle is used to indicate the degree of binding to the column. FIG. 8. shows a Nyquist diagram from EIS measurements where the imaginary part is plotted as a function of the real part of the impedance during a purification process of binding and elution of a bioproduct to/from a support structure of a chromatographic column of FIG. 1b.

FIG. 9 shows an electrical circuit representation used to analyze electrochemical impedance spectroscopy measurements on a polyelectrolytic coating, such as a polymer brush, coated on the working electrode of the chromatography unit in FIG. 1b.

A method of analyzing EIS measurements is creating a model, an electrical representation of the electrical circuit of the system in FIG. 9, where the EIS data Z(ω) is fitted with respect to the following model parameters: Rct (the charge transfer resistance, Zw Warburg impedance, Rs is the solution resistance and Cdl is the capacitance between the working electrode surface and target species of ions in the buffer electrolyte system. The capacitance of the electrical double layer reflects the relative presence of biomolecular product on the surface of the electrode. The capacitance studied as a function of time provides the degree of loading and unloading on the surface of the electrode throughout the chromatography cycle.

### EXAMPLES: METHODS FOR USE

The examples below are provided for illustrative purposes only and should not be construed as limiting.

### Example 1: Chromatography Purification Process Monitored in Real-Time Directly on a Conductive Chromatography Material Using EIS and Compared with Conventional Chromatography

FIG. 4 shows a conceptual comparison of data that is obtained when a chromatography purification process is monitored in real-time directly on a conductive chromatography material using EIS, with the data obtained from a conventional chromatographic purification process that is monitored indirectly by downstream in-line analytical tools such as a UV sensor.

In FIG. 4 is shown (A) onset of binding, (B) saturation of binding, (C) onset of elution and (D) completion of elution, which can be detected directly in real time with EIS when it happens on the surface of the chromatography material before it is recorded on the in-line downstream process analytical sensor (lower graph). Six distinctive features of EIS monitoring versus in-line sensors like UV detectors can be deduced:
1. Location of the product with high accuracy: In bind-and-elute chromatography the product binds to the chromatography material by some specificity. In the case of very specific interactions such as in affinity chromatography e.g. IGG purification by Protein A ligand functionalized chromatography material one can be almost certain that equilibrated signals arising from binding to the surface is 99% product related.
2. Elimination of column to sensor delay time: In-line sensors record in real-time but with a delay from when the product was actually inside the chromatography column, meaning that EIS monitoring has capability of acquiring process information forwarding instructions to electronic hardware of the system or to the operator directly and faster than methods employed today.
3. Minimization of breakthrough and also possibility of its elimination: Today decisions are taken when the sensor signal has increased by a certain value e.g. +200% on the 280 nm UV wavelength. But by then material may already have been wasted.
4. Reduction of invasive elution buffer use/exposure: Knowledge of when the elution beings and finished enables minimization of residence time for the biological substance in potentially harmful environments.
5. Process intensification and efficiency improvement: EIS monitoring obtains direct information of when binding has started, completed, elution has started is complete, chromatography column is equilibrated, when the sample containing impurities has been evacuated from the column. This results in opportunities for faster decision making and a more rapid process over-all.
6. Chromatography unit development: Ground truth data for binding and release of biological substances is not attainable with non-conductive chromatography materials. By direct measurement of these processes optimization of the support structure and the chromatography unit could be used to optimize the design with respect to for instance mass-transfer and binding capacity.

### Example 2: Direct Monitoring of the Binding and Elution of a Biological Substance Using EIS

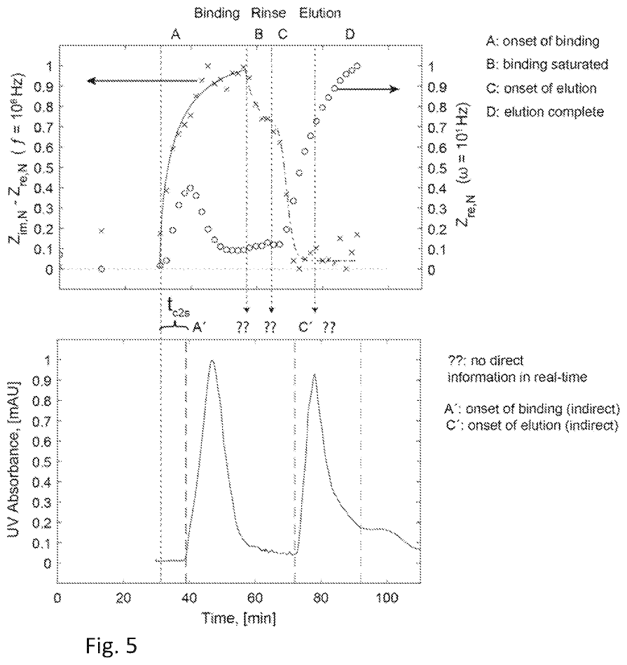

FIG. 5 is an experimental example analogous to the conceptual image provided in FIG. 4. Here the biomolecule substance IGG 0.5 mg/ml is captured to a PAA polyelectrolytic coating functionalized with Protein A using EDC/NHS. We used impedance spectroscopy to interrogate the binding, equilibration, and elution of the biomolecule substance while also simultaneously monitoring the flow of the uncaptured sample through the chromatography unit. The frequency range used was 10 Hz to 1 MHz with a bias potential of −0.2 V, a potential where no electrochemical reactions that alter the interface pH of the support structure will occur at a significant rate, meaning that the EIS scan is passive and will not interfere with binding or release. The bias potential was set to float with respect to the open circuit potential meaning that −0.2 V was applied with respect to the measured OCP which was within the range 76 mV to 300 mV throughout the duration of the experiment.

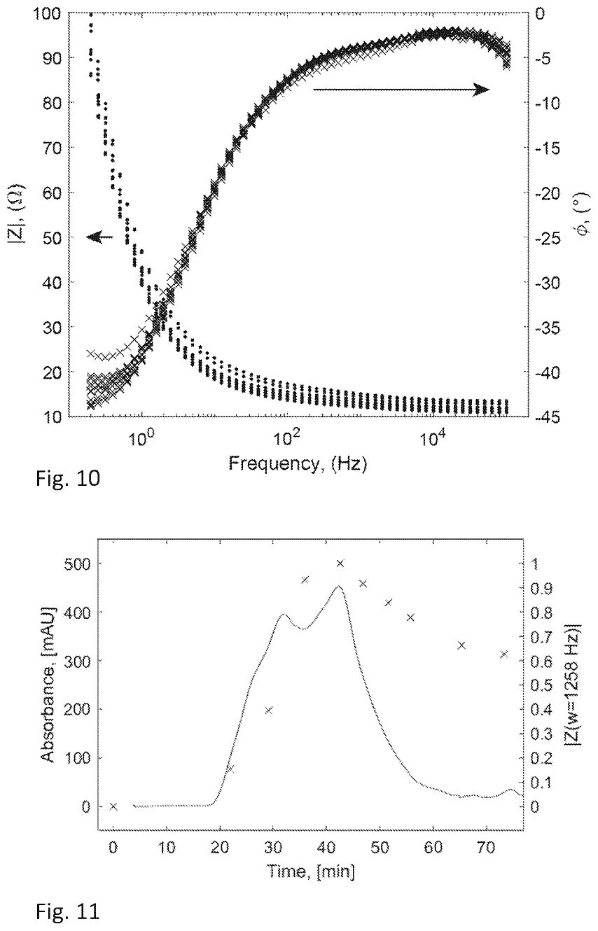

FIG. 8 shows an example of the raw data obtained by EIS represented in a so-called Nyquist plot where the negative imaginary part of the measured impedance signal is plotted against the corresponding real part. FIG. 10 is yet another example of a representation where the each signal is plotted on a separate y-axis as a function of frequency. As the support structure binds, or releases, biomolecular substance to the column the spectra shifts. The spectra will also shift as a function of sample present in the bulk solution, the shifts in the spectra as a function of the frequency is used to elucidate if surface binding or flow of sample through the column is occurring. However, the graphical representations in FIGS. 8 and 10 are poorly suited to visualize and detect real-time changes. Instead select frequency values are analyzed plotted and analyzed throughout the progression of the purification process as shown in FIG. 5.

The resulting normalized impedance signal in FIG. 5 displays on the left hand (crosses) specific binding of IGG to the support structure by detecting a shift in the high frequency 106 Hz. On the right hand axis (circles), low frequency (101 Hz) detects the bulk conductivity of the sample flowing through the chromatography unit First thing to note is the delay time of the UV sensor by tc2s, column-to-sensor, the registration of the sample binding occurs immediately with EIS while it is later with the UV absorbance sensor. The finishing of the binding is registered with EIS as the maximum of the normalized imaginary EIS signal, while for the UV sensor this event goes unnoticed. During the rinsing phase (B) complete equilibration of the biomolecule substance to the support structure and validation of when all the unbound sample has exited the chromatography unit is immediately obtained. The onset of elution (C) when the elution buffer reaches the surface of the support structure is detected immediately, as is the complete unloading of sample from the support structure, both event are delayed information with the UV absorbance sensor, furthermore the end-user cannot be sure the entire quantity of bound biomolecule substance has been released without applying an excess of elution buffer. The EIS signals when returned to the baseline provides information of complete unloading. Similar to SPR and surface sensitive analytics it is possible to fit binding association curves during binding, and dissociation curves for the rinsing phase, furthermore sigmoidal curves and logistics functions to simulate the elution of biomolecular substance from the chromatography units support structure. By doing so modelling of the chromatography material can be efficiently performed and optimization of the chromatography unit can be made with direct information and feedback.

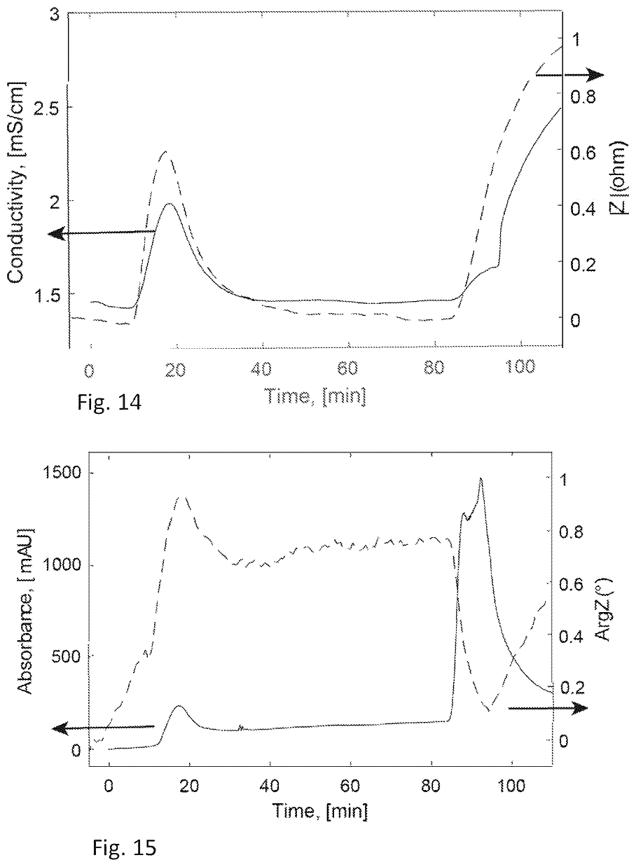

Another experiment where IgG (0.5 mg/mL) is purified using Protein A coated polyelectrolytic coating is shown in FIG. 14 and FIG. 15. Here the impedance signals are collected at a fixed bias potential, −0.2 V, instead of at a floating open circuit potential value. In FIG. 15 the normalized phase angle (dashed line) of the impedance spectra is plotted as function of time (on the right-hand axis) at an intermediate frequency of 400 Hz. In comparison, the UV absorbance at 215 nm is plotted on the left-hand axis. The UV absorbance is shifted in time to compensate for the column to sensor delay time. It is interesting to note that the phase angle begins to increase before the breakthrough is recorded in the UV absorbance signal. During this phase EIS provides direct information on the progress of the binding and loading to the support structure while the UV absorbance signal does not record any change due to the fact that unbound IgG is not yet escaping through the chromatography unit. First, when binding saturates and product exits uncaptured, a breakthrough peak is recorded in the UV signal. The phase angle stabilizes at an equilibrium binding level while the UV signal returns to baseline. When eluting the IgG, the phase angle decreases and returns to its value as unbounded. The unbounde IgG is confirmed since the off-line UV absorbance increases. In FIG. 14 on the other hand, the bulk solution is monitored, where the modulus of the same impedance signal, also at 400 Hz, is plotted as function of time compared to the in-line conductivity sensor. In FIG. 14 and FIG. 15 where the EIS signal is monitored with respect to a fixed potential, the modulus and the phase angle produced on the one hand bulk solution conductivity data, while the phase angle reports surface specific changes at the same frequency. The frequency selected is intermediate, where the impedance spectra is affected by both bulk solution conductivity effects and by changes in capacitance and resistance in the interface. As the elution buffer is injected towards the end of the purification cycle, the phase angle begins to increase again at the end of the pH elution. For concentrated elution buffers, such as the one used in this example, the bulk conductivity signal of the concentrated acidic buffer eventually floods the signal. However, by combining in-line analytics (solid line) with EIS, or by adjusting the properties of the buffer, it is possible to by-pass this issue. By for instance interpreting the impedance signal results with analysis of the modulus of the impedance or by use of in-line sensors such that accurate values for column binding and elution can still be obtained.

### Example 3: Preventing Yield Loss from Breakthrough by Immediate Identification of when the Chromatography Support is Saturated with Product

Using in-line sensors it is very difficult to avoid loss of product due to imperfect information of when the column is fully saturated and is unable to bind more product. Consequently, this makes it very hard to truly minimize waste of product using conventional chromatography. During the bind-and-elute chromatography cycle there is a moment in time where the product breaks through. This is the point during the binding phase when the feed solution is registered flowing out of the chromatography column by the in-line sensors. With standard UV sensors it is not possible to know when the breakthrough contains uncaptured product because the signal is polluted with the background signal from process impurities. Either some loss must be tolerated, or a time-consuming off-line analytical testing is performed to identify at which point of the binding cycle the column becomes saturated. Even if the yield loss for breakthrough is minor for one chromatography step for example 97%, the effect of losing material this amount of sample for four consecutive cycles results in an over-all yield of 61%.

FIG. 11 shows binding of IgG to a support structure with a PAA polyelectrolytic coating that has been functionalized with Protein A. EIS signal is compared against UV absorbance signal where the delay time for the UV signal is subtracted to overlay the signals. In the EIS measurement the modulus of the impedance signal at 1258 Hz is plotted as a function of time during the binding phase where a bias potential of −0.2 V (against the open circuit potential) is used. FIG. 11 clearly shows how the signal reaches a maximum during the sample injection indicating saturation of the support structure with IgG. The corresponding UV signal reaches a maximum during the sample injection as the sample passes through the chromatography unit. With the EIS signal it is possible to gather information that the surface of the support structure may be saturated with biomolecule product. However with the UV signal the peak only indicates that the sample has passed through the chromatography unit. It is not immediately possible to know in real time if the chromatography material has been saturated.

FIG. 11 provides a tool for knowing when the column is saturated in real-time which can be used to steer the chromatography system to prevent excessive loss of product, by cancelling application of new sample. Furthermore the system can immediately proceed to the next step of the purification cycle and start to rinse the chromatography unit. The progression of the rinsing phase can also be monitored by observing stabilization of the EIS signal and evacuation of the unbound sample as may be measured by the low frequency region of the impedance spectra.

### Example 3: Using Direct Information about the Column Loading to Minimize the Time Required for Elution of the Product Using an Elution Buffer

A secondary source of yield loss is encountered during the elution. Elution is induced by some chemical (acid, salt, surfactant, or organic molecule) that breaks the interaction between the product and the chromatography medium. Elution chemicals are problematic as they usually lead to aggregation and degradation of the product molecule if exposure is too long. For instance, in affinity chromatography with monoclonal antibodies, elution is achieved by injecting an acidic pH 3-4 elution buffer. The acidic environment gives rise to some level of aggregation of the product. The loss in yield can be as high as 60% and for certain pH sensitive mAbs the manufacturing costs can be prohibitively high due to very low yields. Optimizing yield relies on identifying an exposure time that prevents degradation by being short enough to prevent excessive yield loss while being long enough to ensure efficient elution. To date there is not process analytical technology that can report in real time the exact degree of loading to the column, which could be used to minimize the duration of the elution buffer step.

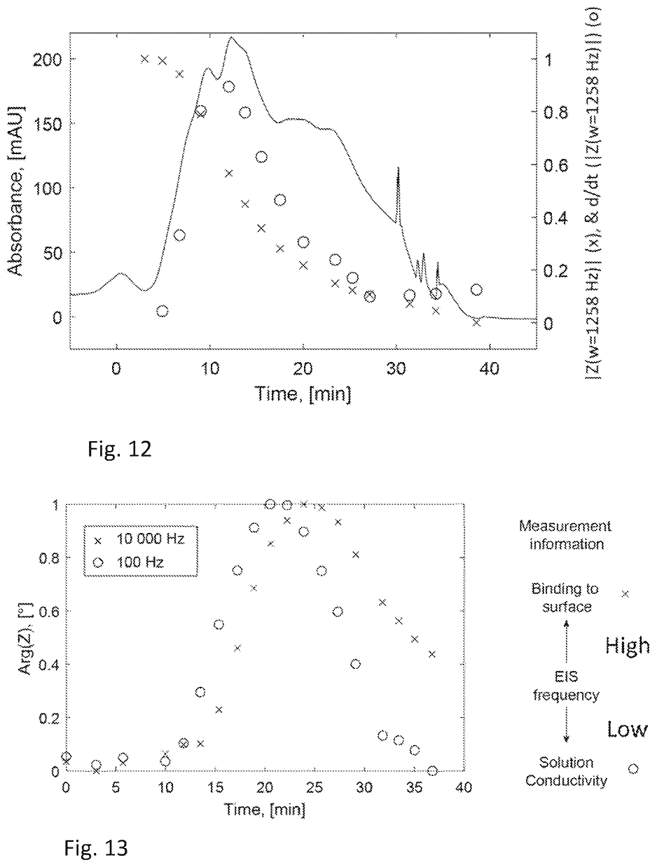

FIG. 12 shows an EIS and UV measurement of the elution of IGG from a Protein A coated PAA polyelectrolytic coating. The EIS spectra was measured in a range between 100 Hz to 1e6 Hz where in FIG. 12 the frequency value of 1258 Hz is shown. The EIS scans were produced with a bias potential of −0.2 V ensuring passive non-invasive monitoring of the elution process and where a solution holding pH 3 was injected to induce elution of the bound IGG. The EIS signal and its derivative is plotted in crosses (x) and circles (∘) respectively while the UV absorbance signals is shown as a solid line (−). The column-to-sensor delay time is subtracted from the UV absorbance signal to overlay the signals. FIG. 12 shows how the EIS signal provides direct real-time continuous information of how the column is emptying from 100% full to 0% and to what extent while the UV absorbance signal produces a peak with a delay. With EIS monitoring it is possible to reduce the amount of elution buffer used, and the duration to which the product needs to be exposed.

### Example 4: Direct in-Line Quantification (Concentration) of Product During the Purification Process

The current purification workflow with standard chromatography, see scheme of FIG. 6, lacks information about the concentration of product that flows through the system in true real time. This is because the current analytical techniques are mainly used for process control and it is hard and simply too difficult to know with certainty that any of the signals detect the product specifically. Therefore, quantification of the product is performed with off-line techniques. However, an in-line quantification would be highly desirable.

With the system for monitoring the purification process described here, see FIG. 3, it is possible to detect in real time the binding curve, similar to an SPR experiment, using the EIS signal. Indeed, FIG. 5 and FIG. 15 show examples that highlight how the degree of the column loading may be measured ranging from completely empty 0% to completely full 100% at any given point of the chromatogram.

While the relative loading of the column is important in a bioproduction process it is even more useful to be able to output the actual concentration of product at any given time bound to the chromatography column. Using the system described herein one can utilize the combined knowledge of (A) the device surface area and (B) knowledge of the polymer coating binding capacity to calculate the concentration of product bound to the column directly on the surface in real time during the purification process.
(A) Determination of the electroactive surface area.
   With a redox-couple such as Ferricyanide the surface area of an electrode can be determined. This provides information of the available internal surface area of the system. By potential cyclic voltammetry in the presence of a redox couple the effective surface area of the working electrode was calculated by calculating the peak area the cathodic CV peak and applying the relationship:

$$A = Q / \{ 482 μC cm - 2 )$$

Another alternative is to also utilize EIS to find the double layer capacitance of the electrode and compare it to the capacitance with a known area.
(B) Determination of the polymer coating binding capacity
   The polymer coating binding capacity can be determined in multiple ways: By knowledge of the binding capacity of the coating on an analytical sensor QCM-D or SPR for instance, the coatings capacity on a scaled up microporous electrode can be determined by knowledge of the effective surface area of the electrode (A).
   Another option is to directly calibrate the device as described in FIG. 1 with different samples of a known concentration of bioproduct. The corresponding EIS signal and the eluted sample measured can be used to benchmark the binding capacity.

For affinity chromatography there is high certainty that the binding readout is the specific product of interest. The best location for an over-all concentration measurement of the product in the process is therefore during the rinse and washing step following product binding.

### Example 5: Determination of the Potency Equilibrium Binding Constant of the Product Directly from the Chromatography Purification Process Using the EIS Signal Readout

The current chromatography workflow is completely reliant on off-line analysis of the collected fractions to assess the potency of the product. Common technologies for performing equilibrium binding constant are SPR and ELISA. Different concentrations of the target molecule are bound to surfaces and from the readout the binding constant is extracted. The chromatography system described herein could be used to determine binding constants directly in-line. By measuring the binding curve of the product to the chromatography support using EIS and for different concentrations.

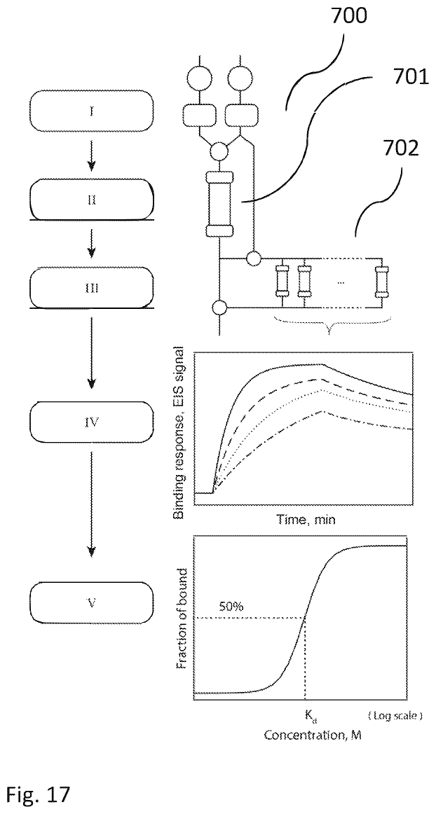

FIG. 17 shows how a network of smaller chromatography columns that are connected in a flow scheme where the effluent holding a known concentration of product can be used together with background buffer and a mixing valve to obtain binding data at different concentrations where association and dissociation is measured on analytical column(s) to produce in-line potency and Kd values that can be used for direct decision-making with respect to validating quality critical attributes and confirming/clearing the finished product.

The system described in FIG. 17 would furthermore be waste since the analyzed samples could be returned to the total process stream. It would be possible to greatly extend the quantity of tested sample compared to SPR and ELISAs which utilize micrograms of sample whereas a chromatography based Kd measurement could validate a much larger proportion of the product feed with less resources and greater extent of automation.

### Example 6: Using the EIS Signal to Monitor the pH and Conductivity of the Bulk Solution

The frequency of the EIS signal measures charge transport through the polymer coating between the electrolyte and the electrode chromatography support at different timescales. There is a frequency dependency that can be exploited to understand the bulk solution properties and to distinguish these from the surface specific properties, the binding of product within the polymer coating for instance. In FIG. 13 the conductivity is measured at high frequencies while the binding to the surface is measured at lower frequencies. The EIS measurements performed on the chromatography support structure can be used to monitor the bulk electrolyte environment and properties like conductivity, and pH of the buffer solution that flows through the chromatography unit in-situ. Another example is provided in FIG. 14, where the in-line conductivity is plotted against the measured conductivity signal showing a very close resemblance between the two signals. Effectively certain in-line sensors can be replaced with a conductive chromatography material that passively monitors properties of the bulk and surface of the chromatography unit.

### Example 7: Real-Time Monitoring Through a Porous Support Structure Comprising a Stack of Distinct Layers

The support structure with stacked layers has a thickness of 1 cm-100 cm and achieves resolution along the axial direction of the support structure and in the flow direction from the solution inlet to the solution outlet.

For preparative purification applications the support structure, the length of the working electrode, may need to be increased to match the required binding capacity. For a larger length of the electrode it may be challenging to resolve real-time binding capacity at the inlet of the column vs the outlet of the column. To achieve resolution along the flow direction of the column it may be advantageous to divide the support structure, working electrode, into multiple discrete layers that are physically separated, and to have each discrete layer of the working electrode connected to a potentiostat unit that monitors the AC signal in real-time simultaneously on all working electrode discrete layers in a parallelized multiplexed manner. Examples of how such a design looks is shown in FIGS. 18a-18c. The fluid first flows through the counter electrode 102 where the counter electrode acts as a flow distributor, following this the liquid flows into the first discrete layer 101a of the working electrode and thereafter through each discrete layer of the electrode until it reaches the final discrete layer 101n of the working electrode stack before it exits the chromatography column.

In FIG. 18b, the working electrode stack is fitted in the center of the device and the counter electrode 102 is wrapped around the working electrode stack 101. In this manner the counter electrode is efficiently interfaced equally with all the working electrodes of the system.

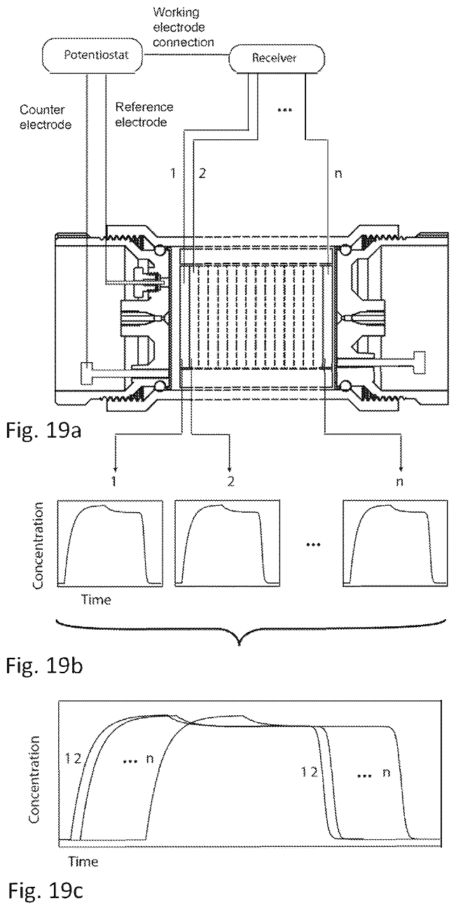

As fluid flows through the chromatography column device AC signals are used to track the concentration of bound biological substance to the electrode, and the flow of impurities through the bulk, in real-time through all discrete layers of the working electrode. Collecting all the surface and bulk solution information throughout the chromatography column provides the user with the possibility to orchestrate the binding and elution in time and space, see FIGS. 19a-19c.

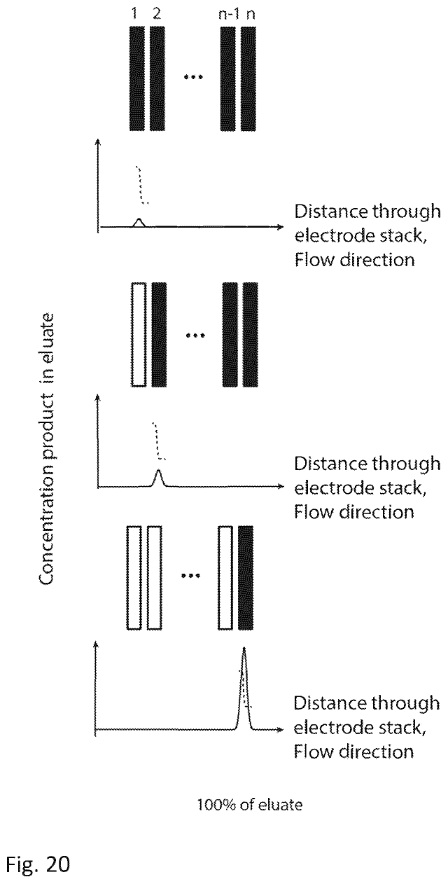

Efficient elution of the biological substance is achieved by sequentially performing elution with ground truth data feedback in real-time as shown in the flow chart in FIG. 20. FIG. 20 depicts the saturated working electrode discrete layers (black bars) and fully eluted discrete layers (white bars) and graphs showing the location of the eluted biological substance as measured using AC voltage signals by EIS, which provides both the degree of binding of product to the surface of the working electrode, and the presence of eluted biological substance from upstream electrode discrete layers in real-time.

Elution is achieved either by changing the bias potential such that release of bound substance triggered by electrochemistry, or by injecting a chemical that triggers elution. If electrochemistry is used each segment of the working electrode elutes with feedback in such a manner that the concentration of the eluate is maximized and such that a minimum amount of electrochemistry is applied. When eluted biological substance is registered in the bulk solution of the neighboring electrode discrete layer the algorithm controlling the potentiostat automatically responds by eluting from that electrode discrete layer. In this manner elution can be steered to maximize output concentration of the biological substance. Even if chemicals are consumed, real-time monitoring can be used to optimize the process with fast feedback to upstream pumps ensuring that a minimum amount of elution chemicals and solvent is used to completely empty the working electrode structure from the biological substance.

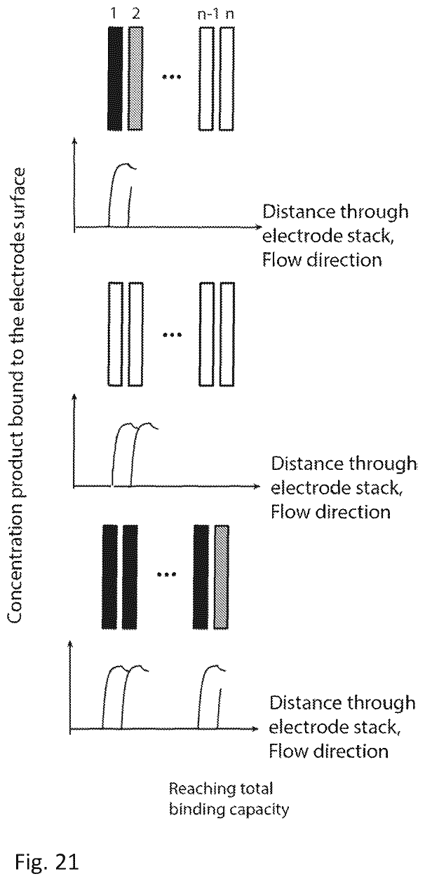

FIG. 21 shows continuous tracking of the concentration of bound material to the electrode surface. In situ real-time monitoring along the direction of the chromatography support structure stack allows highly efficient use of supernatant solution even for working electrodes with a large stack height with minimum sample loss due to overfeeding. In FIG. 21 filled bars correspond to fully saturated working electrode discrete layers, grey indicate partially filled and white denote empty working electrode discrete layers. Monitoring the binding by division into n segments permits tracking of the degree of binding to a thick electrode stack by 0-100%/n where n is the number of electrode discrete layers. The working electrodes are all connected in parallel to a potentiostat device, which is measuring AC voltages producing for instance an EIS spectrum where separation between the bulk solution properties and the surface properties can be de-coupled. In such a way information about the location of impurities being rinsed away from the working electrode can be monitored with high precision along the working electrode stack and through the chromatography column enabling the algorithm that steers the purification process to limit the amount of excess solution being fed through the system.

### Example 8: Real-Time Monitoring In-Situ of the Chromatography Column Devices

FIG. 18c shows a chromatography column wherein the support structure/working electrode 101 consists of three discrete layers 101a, 101b, 101c. Each electrode contains a different polyelectrolytic coating. The first coating is a capture step where the coating is functionalized with affinity ligands, the second coating is for polishing where this electrode segment contains a polyelectrolytic coating with ion-exchange properties, the third segment is also a polishing step where the biological substance of interest is separated from remaining impurities by hydrophobic interactions. Each discrete layer of the working electrode is connected in parallel to a potentiostat device such that all steps, all different mechanisms of purification are monitored sequentially in real-time. All steps are controlled by setting a bias potential to a value that results in elution for each segment of interest. When the AC signal detects saturated binding in combination with no impurities present in the bulk solution of a single discrete layer the algorithm produces elution from that discrete layer, which triggers a downstream cascade of decision in terms of monitoring the neighboring discrete layer.

Purification using the column in FIG. 18c can potentially be the only chromatography step a purification process needs as it can cover all mechanisms by which a biological substance is today purified. Avoiding multiple separate unit operations (passing product through multiple different columns) is time consuming and results in a yield loss for each step, even small yield losses produce a large compounding loss of yield when there are multiple steps. Naturally, elimination of compounded yield loss is of interest. However, it is difficult to create a chromatography device that incorporates multiple mechanism of separation as the chromatography column is a black box, controlled in the upstream, and analysis is conducted downstream, in-line and off-line. Furthermore, most chromatography materials employ elution buffers that are incompatible with each other. For instance, strong acids or imidazole are elution buffers used for affinity and IMAC chromatography and these may not be compatible with resin and membranes materials for ion-exchange and hydrophobic interaction. In summary, the purification device and technology behind enables the use of multiple (>2) different mechanisms of purification into a single chromatography unit step, by employing non-invasive EIS monitoring for in-situ tracking of product and impurities, and invasive electrochemical elution as a universal in-situ local elution mechanism.

### DISCUSSION

We have shown a chromatography system that uses EIS as a process analytical technology. Contrary to using sensors as in-line or in-situ tools to monitor the process we use the entire chromatography support to measure the binding of the entire product sample directly in real-time. The scale of the measurement is preparative, not analytical scale, highlighting the potential of this technology to be utilized for industrial scale manufacturing and its industrial applicability. The scope for using the technology is to reduce losses and measure quality critical attributes directly in the purification process increasing yield and creating a more efficient manufacturing workflow. This should intensify the shift towards much needed digitalization and automation of bio-production process. The outcome of this technology shift will be reduced cost of goods thanks to lower product loss, and faster production times.

1. A chromatography unit (200) for use in a chromatography system for real-time monitoring of purification of a biological substance, the chromatography unit (200) comprising:
a chromatography column (100) comprising a housing (110) provided with a solution inlet (107) and a solution outlet (108),
a support structure (101, 101a-101n) arranged in the housing (110) in a space between the solution inlet (107) and the solution outlet (108) and being arranged such that an electrolytic solution arranged to flow (F) from the solution inlet to the solution outlet is contacting at least a portion of the support structure (101, 101a-101n), wherein at least a portion of a surface of said support structure is electrically conductive,
a) a counter electrode (102) arranged in the housing (110) and arranged in electrical connection with the support structure (101, 101a-101n) via the electrolytic solution arranged to flow from the solution inlet (107) to the solution outlet (108), or
b) a counter electrode (102) and a reference electrode (103) arranged in the housing and arranged to be in electrical connection with each other and with the support structure (101, 101a-101n) via the electrolytic solution arranged to flow from the solution inlet (107) to the solution outlet (108),
wherein said at least a portion of a surface of the support structure (101) is provided with a polyelectrolytic coating (111), the polyelectrolytic coating (111) being arranged to be switchable between a first state in which a biological substance to be purified is captured on the support structure and a second state in which captured biological substance is released from the support structure,
a voltage generator (300) is arranged to be connected to the support structure (101, 101a-101n) and
a) to the counter electrode (102), and being arranged to provide an AC voltage signal at a bias between the support structure (101, 101a-101n) and the counter electrode (102), or
b) to the counter electrode (102) and the reference electrode (103), and being arranged to provide an AC voltage signal at a bias between the support structure (101, 101a-101n) and the reference electrode (103),
a recorder (300) arranged to record a current signal and/or potential signal generated between the support structure (101, 101a-101n) and the counter electrode (102) or between the support structure (101, 101a-101n) and the reference electrode (103).

2. The chromatography unit (200) of claim 1, wherein the support structure (101) has a stacked structure comprising at least two discrete layers (101a-101n) physically separated from each other and being arranged such that an electrolytic solution arranged to flow (F) from the solution inlet (107) to the solution outlet (108) is contacting at least a portion of each discrete layer (101a-101n), wherein at least one of the discrete layers is provided with a polyelectrolytic coating, and wherein the voltage generator (300) is arranged to be connected to each or to at least a majority of the discrete layers (101a-101n) of the support structure (101), and the recorder (300) is arranged to record a current signal and/or potential signal generated between each discrete layer (101a-101n), or a majority of the discrete layers (101a-101n), of the support structure (101) and the counter electrode (102) or the reference electrode (103).

3. The chromatography unit (200) of claim 2, wherein the support structure (101) comprises at least a first and second discrete layer (101a, 101b), wherein the polyelectrolytic coating arranged on the first discrete layer (101a) differs in chemical composition from the polyelectrolytic coating arranged on the second discrete layer (101b).

4. A chromatography system (400) comprising the chromatography unit (200) of claim 1.

5. A method for real-time monitoring of chromatographic purification of a biological substance, comprising:
i) obtaining an electrolytic solution volume comprising a biological substance to be purified and contaminant(s),
ii) providing the chromatography system (400) of claim 4,
iiia) applying an AC potential with a bias potential difference between the support structure (101, 101a-101n) and the counter electrode (102), and, optionally, measuring an open circuit potential between the support structure (101, 101a-101n) and the counter electrode (102), or
iiib) applying an AC potential with a bias potential difference between the support structure (101, 101a-101n) and the reference electrode (103),
iv) supplying an electrolytic running buffer to the housing (110) at the solution inlet (107) of the chromatography column (100), equilibrating the polyelectrolytic coating (111) of the support structure (101, 101a-101n) in the electrolytic running buffer,
v) setting the polyelectrolytic coating (111) arranged on the support structure (101, 101a-101n) into its first state,
vi) supplying the electrolytic solution volume comprising a biological substance to be purified and contaminant(s) to the housing (110) at the solution inlet (107) of the chromatography column (100), thereby biological substances are captured in the polyelectrolytic coating on the support structure (101, 101a-101n),
vii) setting the polyelectrolytic coating (111) arranged on the support structure in its second state, thereby captured biological substances are released from the support structure (101, 101a-101n), and
viii) recording a current signal and/or potential signal generated between the support structure (101, 101a-101n) and the counter electrode (102) or between the support structure (101, 101a-101n) and the reference electrode (103) during step iv) to vii).

6. The method of claim 5, wherein when the support structure (101) has a stacked structure comprising at least two discrete layers (101a-101n), in step iiia) an AC potential with a bias potential difference is applied between each or at least a majority of the discrete layers (101a-101n) and the counter electrode (102), and, optionally, an open circuit potential is measured between each or at least a majority of the discrete layers (101a-101n) and the counter electrode (102), or in step iiib) an AC potential with a bias potential difference is applied between each or at least a majority of the discrete layers (101a-101n) and the reference electrode (103), and in step viii) recording a current signal and/or potential signal generated between each or at least a majority of the discrete layers (101a-101n) and the counter electrode (102) or between each or at least a majority of the discrete layers (101a-101n) and the reference electrode (103) during step iv) to vii).

7. The method of claim 6, wherein in step v) setting the polyelectrolytic coating (111) arranged on the support structure in its first state comprises changing/switching the bias potential difference of the applied AC potential.

8. The method of claim 5, wherein in step vii) setting the polyelectrolytic coating (111) arranged on the support structure in its second state comprises changing/switching the bias potential difference of the applied AC potential.

9. The method of claim 5, wherein in step v) setting the polyelectrolytic coating (111) arranged on the support structure in its first state is performed in step iv) through the electrolytic running buffer used.

10. The method of claim 5, wherein in step vii) setting the polyelectrolytic coating (111) arranged on the support structure in its second state comprises adding an elution buffer to the chromatography unit.

11. The method of claim 5, further comprising a rinsing step after step vi).

12. The method of claim 5, further comprising a step of collecting biological substances released from the support structure (101, 101a-101n) and exiting through the solution outlet (108).

13. The method of claim 5, wherein the applied biased alternating potential has a bias potential of +/−1.5 V.

14. The method of claim 5, wherein the applied biased alternating potential has a frequency of 1 μHz to 1 MHz.

15. The method of claim 5, wherein an amplitude of the alternating potential is 1 μV to 100 mV.

16. The method of claim 5, further comprise a step of, based on the recorded current signal and/or potential signal from step viii), provide real-time information on: bulk electrolytic solution properties, degree of binding/saturation of the biological substance captured by the polyelectrolytic coating, degree of column loaded with biological substance, potency of the biological substance, concentration of the biological substance captured by the polyelectrolytic coating, pH of the electrolytic solution, and/or conductivity of the electrolytic solution.

17. The method of claim 16, wherein the provided real-time information is used in a feedback loop to control step vi) and/or step vii).

18. The method of claim 5, wherein the electrolytic running buffer and the electrolytic solution volume comprising a biological substance to be purified is supplied to the housing (110) at the solution inlet (107) at a flow rate of 0.1-10 ml/min.

19. The method of claim 18, wherein the flow rate is a continuous flow rate with a maximum change in flow rate of 0.5 ml/min.
